(19) United States
(12) Patent Application Publication
(10) Pub. No.: US 2026/0235851 A1
(43) Pub. Date: Aug. 13, 2026

(54) IMAGING LENS SYSTEM, IMAGE CAPTURING UNIT AND ELECTRONIC DEVICE

(71) Applicant: LARGAN PRECISION CO., LTD., Taichung City (TW)

(72) Inventors: Chun-Yen CHEN, Taichung City (TW); Guan-Jr LIAO, Taichung City (TW)

(73) Assignee: LARGAN PRECISION CO., LTD., Taichung City (TW)

(21) Appl. No.: 19/179,375

(22) Filed: Apr. 15, 2025

(30) Foreign Application Priority Data
Feb. 7, 2025 (TW) 114104609

(51) Int. Cl. G02B 13/00; G02B 9/60; G02B 13/02; H04N 23/55

(52) U.S. Cl. CPC G02B 13/0045; G02B 9/60; G02B 13/0065; G02B 13/02; H04N 23/55

(57) ABSTRACT

An imaging lens system includes five lens elements which are, in order from an object side to an image side along an optical path: a first lens element, a second lens element, a third lens element, a fourth lens element and a fifth lens element. Each of the five lens elements has an object-side surface facing toward the object side and an image-side surface facing toward the image side. The first lens element has positive refractive power. The second lens element has negative refractive power, and the image-side surface of the second lens element is concave in a paraxial region thereof.

### RELATED APPLICATIONS

This application claims priority to Taiwan Application 114104609, filed on Feb. 7, 2025, which is incorporated by reference herein in its entirety.

### BACKGROUND

### Technical Field

The present disclosure relates to an imaging lens system, an image capturing unit and an electronic device, more particularly to an imaging lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an imaging lens system includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

Preferably, the first lens element has positive refractive power. Preferably, the second lens element has negative refractive power. Preferably, the image-side surface of the second lens element is concave in a paraxial region thereof.

When an axial distance between the object-side surface of the first lens element and the image-side surface of the third lens element is Dr1r6, an axial distance between the object-side surface of the fourth lens element and the image-side surface of the fifth lens element is Dr7r10, an axial distance between the object-side surface of the first lens element and the image-side surface of the fifth lens element is TD, an axial distance between the image-side surface of the fifth lens element and an image surface is BL, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an Abbe number of the fourth lens element is V4, a curvature radius of the image-side surface of the second lens element is R4, and a curvature radius of the image-side surface of the fifth lens element is R10, the following conditions are preferably satisfied:

$$1.6 < Dr 1 r 6 / Dr 7 r 10 < 5. ;$$

$$0.5 < TD / BL < 1.5 ;$$

$$0. < ( T 12 + T 23 + T 45 ) / T 34 < 0 \text{.50} ;$$

$$0. < T 23 / T 45 < 0 \text{.50} ;$$

$$5. < V 4 < 35. ; and$$

$$0. < \vert R 4 / R 10 \vert < 1. .$$

According to another aspect of the present disclosure, an imaging lens system includes five lens elements. The five lens elements are, in order from an object side to an image side along an optical path, a first lens element, a second lens element, a third lens element, a fourth lens element and a fifth lens element. Each of the five lens elements has an object-side surface facing toward the object side and an image-side surface facing toward the image side.

Preferably, the first lens element has positive refractive power. Preferably, the second lens element has negative refractive power. Preferably, the object-side surface of the second lens element is convex in a paraxial region thereof. Preferably, the object-side surface of the fifth lens element is concave in a paraxial region thereof.

When an axial distance between the object-side surface of the first lens element and the image-side surface of the third lens element is Dr1r6, an axial distance between the object-side surface of the fourth lens element and the image-side surface of the fifth lens element is Dr7r10, an axial distance between the object-side surface of the first lens element and the image-side surface of the fifth lens element is TD, an axial distance between the image-side surface of the fifth lens element and an image surface is BL, an axial distance between the first lens element and the second lens element is T12, an axial distance between the second lens element and the third lens element is T23, an axial distance between the third lens element and the fourth lens element is T34, and an axial distance between the fourth lens element and the fifth lens element is T45, the following conditions are preferably satisfied:

$$1.6 < Dr 1 r 6 / Dr 7 r 10 < 5. ;$$

$$0.5 < TD / BL < 1.5 ;$$

$$0. < ( T 12 + T 23 + T 45 ) / T 34 < 0.5 ; and$$

$$0. < T 23 / T 45 < 0.50 .$$

According to another aspect of the present disclosure, an image capturing unit includes one of the aforementioned imaging lens systems and an image sensor, wherein the image sensor is disposed on the image surface of the imaging lens system.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves and a distortion curve of the image capturing unit according to the 10th embodiment;

FIG. 21 is a perspective view of an image capturing unit according to the 11th embodiment of the present disclosure;

FIG. 22 is one perspective view of an electronic device according to the 12th embodiment of the present disclosure;

FIG. 23 is another perspective view of the electronic device in FIG. 22;

FIG. 24 is a block diagram of the electronic device in FIG. 22;

FIG. 25 is one schematic view of an electronic device according to the 13th embodiment of the present disclosure;

FIG. 26 is another schematic view of the electronic device in FIG. 25;

FIG. 27 is a perspective view of an electronic device according to the 14th embodiment of the present disclosure;

FIG. 28 is a perspective view of an electronic device according to the 15th embodiment of the present disclosure;

FIG. 29 shows a schematic view of inflection points and critical points on lens surfaces according to the 1st embodiment of the present disclosure;

FIG. 30 shows a schematic view of Y1R1, Y3R2, Y4R1 and Y5R2 according to the 1st embodiment of the present disclosure;

FIG. 31 shows a schematic view of a configuration of one reflective element in an imaging lens system according to one embodiment of the present disclosure;

FIG. 32 shows a schematic view of another configuration of one reflective element in an imaging lens system according to one embodiment of the present disclosure; and

FIG. 33 shows a schematic view of a configuration of two reflective elements in an imaging lens system according to one embodiment of the present disclosure.

### DETAILED DESCRIPTION

An imaging lens system includes five lens elements. The five lens elements are, in order from an object side to an image side along an optical path, a first lens element, a second lens element, a third lens element, a fourth lens element and a fifth lens element. Each of the five lens elements of the imaging lens system has an object-side surface facing toward the object side and an image-side surface facing toward the image side.

The first lens element can have positive refractive power. Therefore, it is favorable for reducing size and enhancing the light-converging capability of the imaging lens system. The object-side surface of the first lens element is convex in a paraxial region thereof. Therefore, it is favorable for adjusting the refractive power of the first lens element and the field of view of the imaging lens system.

The second lens element can have negative refractive power. Therefore, it is favorable for correcting spherical aberration of the imaging lens system. The object-side surface of the second lens element can be convex in a paraxial region thereof. Therefore, it is favorable for adjusting the refractive power of the second lens element to balance spherical aberration of the imaging lens system. The image-side surface of the second lens element can be concave in a paraxial region thereof. Therefore, it is favorable for correcting astigmatism of the imaging lens system to balance image quality between the center and periphery of the image.

The object-side surface of the third lens element can be convex in a paraxial region thereof. Therefore, it is favorable for cooperating with the shape of the image-side surface of the second lens element to reduce the size of the object-side end of the imaging lens system. The image-side surface of the third lens element can be concave in a paraxial region thereof. Therefore, it is favorable for adjusting the refraction direction of light from the image-side surface of the third lens element to reduce the generation of stray light.

The fourth lens element can have positive refractive power. Therefore, it is favorable for converging light.

The object-side surface of the fifth lens element can be concave in a paraxial region thereof. Therefore, it is favorable for adjusting the shape of the fifth lens element to correct off-axis field curvature.

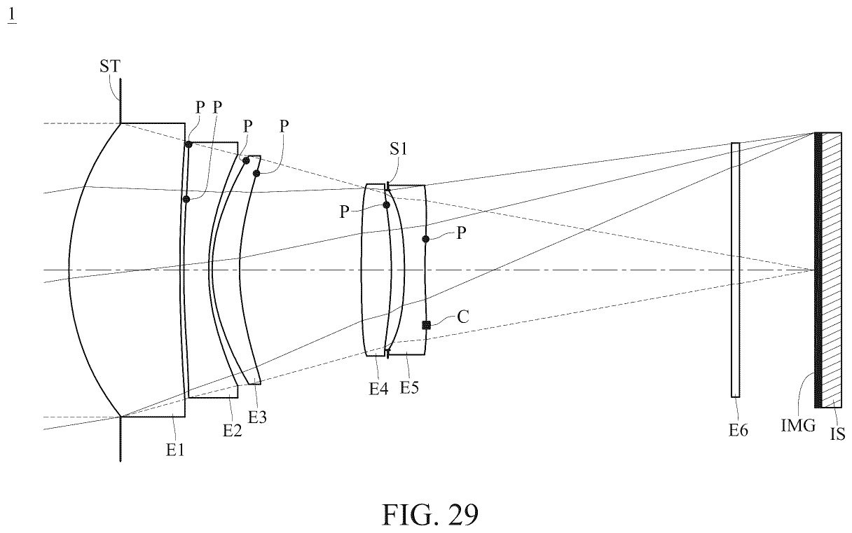

Among the five lens elements of the imaging lens system, there can be at least one lens element having at least one inflection point. In detail, among the first lens element through the fifth lens element, there can be one or more lens elements each having at least one inflection point, and said one lens element having at least one inflection point refers to a lens element in which at least one of the object-side surface and the image-side surface has at least one inflection point. Therefore, it is favorable for increasing optical design flexibility so as to correct aberrations. Please refer to FIG. 29, which shows a schematic view of the inflection points P on the lens surfaces according to the 1st embodiment of the present disclosure. In FIG. 29, the object-side surface and the image-side surface of the third lens element E3, the image-side surface of the fourth lens element E4 and the image-side surface of the fifth lens element E5 each have one inflection point P, and the object-side surface of the second lens element E2 has two inflection points P. The 1st embodiment of the present disclosure shown in FIG. 29 is only exemplary. Each of the lens surfaces of the lens elements in various embodiments of the present disclosure can have one or more inflection points.

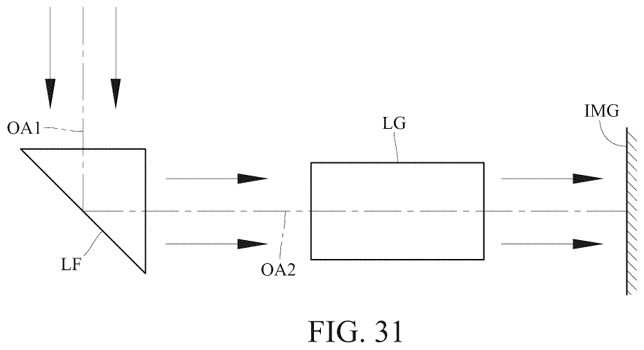

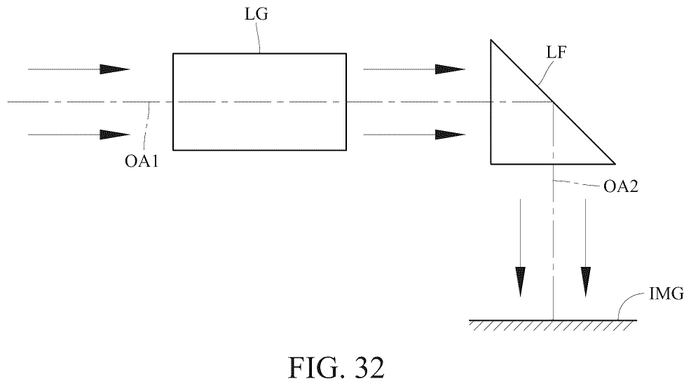

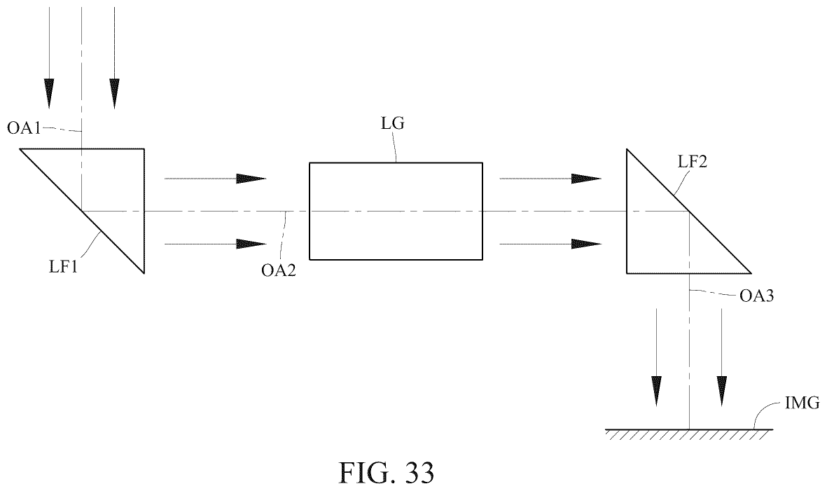

According to the present disclosure, the imaging lens system can further include at least one reflective element. Therefore, it is favorable for providing different optical path directions for the imaging lens system, thereby making spatial arrangement more flexible to reduce mechanical constraints and facilitate the miniaturization of the imaging lens system. In specific, in the imaging lens system of the present disclosure, at least one reflective element, such as a prism or a mirror, can be optionally provided between an imaged object and the image surface on the imaging optical path, and the surface shape of the prism or mirror can be planar, spherical, aspheric or freeform surface, such that the imaging lens system can be more flexible in space arrangement, and therefore the dimensions of an electronic device is not restricted by the total track length of the imaging lens system. Moreover, please refer to FIG. 31 and FIG. 32. FIG. 31 shows a schematic view of a configuration of one reflective element in an imaging lens system according to one embodiment of the present disclosure, and FIG. 32 shows a schematic view of another configuration of one reflective element in an imaging lens system according to one embodiment of the present disclosure. In FIG. 31 and FIG. 32, the imaging lens system can have, in order from an imaged object (not shown in the figures) to an image surface IMG along an optical path, a first optical axis OA1, a reflective element LF and a second optical axis OA2. The reflective element LF can be disposed between the imaged object and a lens group LG of the imaging lens system as shown in FIG. 31, or disposed between a lens group LG and the image surface IMG of the imaging lens system as shown in FIG. 32. Furthermore, please refer to FIG. 33, which shows a schematic view of a configuration of two reflective elements in an imaging lens system according to one embodiment of the present disclosure. In FIG. 33, the imaging lens system can have, in order from an imaged object (not shown in the figure) to an image surface IMG along an optical path, a first optical axis OA1, a first reflective element LF1, a second optical axis OA2, a second reflective element LF2 and a third optical axis OA3. The first reflective element LF1 is disposed between the imaged object and a lens group LG of the imaging lens system, the second reflective element LF2 is disposed between the lens group LG and the image surface IMG of the imaging lens system, and the travelling direction of light on the first optical axis OA1 can be the same direction as the travelling direction of light on the third optical axis OA3 as shown in FIG. 33. The imaging lens system can be optionally provided with three or more reflective elements, and the present disclosure is not limited to the type, amount and position of the reflective elements of the embodiments disclosed in the aforementioned figures.

When an axial distance between the object-side surface of the first lens element and the image-side surface of the third lens element is Dr1r6, and an axial distance between the object-side surface of the fourth lens element and the image-side surface of the fifth lens element is Dr7r10, the following condition can be satisfied: 1.60<Dr1r6/Dr7r10<5.00. Therefore, it is favorable for reducing the size of the image-side end of the imaging lens system and enhancing image quality. Moreover, the following condition can also be satisfied: 1.70<Dr1r6/Dr7r10<4.00. Moreover, the following condition can also be satisfied: 1.81≤Dr1r6/Dr7r10≤3.58.

When an axial distance between the object-side surface of the first lens element and the image-side surface of the fifth lens element is TD, and an axial distance between the image-side surface of the fifth lens element and an image surface is BL, the following condition can be satisfied: 0.50<TD/BL<1.50. Therefore, it is favorable for enhancing the telephoto capability of the imaging lens system. Moreover, the following condition can also be satisfied: 0.55<TD/BL<1.35. Moreover, the following condition can also be satisfied: 0.60<TD/BL<1.20. Moreover, the following condition can also be satisfied: 0.77≤TD/BL≤1.02.

When an axial distance between the first lens element and the second lens element is T12, an axial distance between the second lens element and the third lens element is T23, an axial distance between the third lens element and the fourth lens element is T34, and an axial distance between the fourth lens element and the fifth lens element is T45, the following condition can be satisfied: 0.00<(T12+T23+T45)/T34<0.50. Therefore, it is favorable for adjusting the ratio of the axial distance between the third lens element and the fourth lens element to the total axial distance of all other adjacent lens elements to reduce manufacturing tolerances. Moreover, the following condition can also be satisfied: 0.05<(T12+T23+T45)/T34<0.45. Moreover, the following condition can also be satisfied: 0.10≤(T12+T23+T45)/T34≤0.42.

When the axial distance between the second lens element and the third lens element is T23, and the axial distance between the fourth lens element and the fifth lens element is T45, the following condition can be satisfied: 0.00<T23/T45<0.50. Therefore, it is favorable for controlling the ratio of the axial distance between the second lens element and the third lens element to the axial distance between the fourth lens element and the fifth lens element to reduce manufacturing sensitivity while correcting aberrations. Moreover, the following condition can also be satisfied: 0.00<T23/T45<0.45. Moreover, the following condition can also be satisfied: 0.00<T23/T45<0.40. Moreover, the following condition can also be satisfied: 0.05≤T23/T45≤0.35.

When an Abbe number of the fourth lens element is V4, the following condition can be satisfied: 5.0<V4<35.0. Therefore, it is favorable for adjusting the Abbe number of the fourth lens element to correct chromatic aberration in the imaging lens system. Moreover, the following condition can also be satisfied: 10.0<V4<30.0. Moreover, the following condition can also be satisfied: 16.3≤V4≤25.3.

When a curvature radius of the image-side surface of the second lens element is R4, and a curvature radius of the image-side surface of the fifth lens element is R10, the following condition can be satisfied: 0.00<|R4/R10|<1.00. Therefore, it is favorable for correcting coma and improving light-converging quality both near the optical axis and off-axis. Moreover, the following condition can also be satisfied: 0.00<|R4/R10|<0.90. Moreover, the following condition can also be satisfied: 0.00<|R4/R10|<0.80. Moreover, the following condition can also be satisfied: 0.06≤|R4/R10|≤0.72.

When a focal length of the imaging lens system is f, and a focal length of the third lens element is f3, the following condition can be satisfied: −0.25<f/f3<5.00. Therefore, it is favorable for assisting in balancing the refractive power at the object-side and image-side ends of the imaging lens system to correct aberrations in the imaging lens system. Moreover, the following condition can also be satisfied: −0.25<f/f3<3.00. Moreover, the following condition can also be satisfied: −0.20<f/f3<2.00. Moreover, the following condition can also be satisfied: −0.15<f/f3<1.60.

When the axial distance between the image-side surface of the fifth lens element and the image surface is BL, and a maximum image height of the imaging lens system (which can be half of a diagonal length of an effective photosensitive area of an image sensor) is ImgH, the following condition can be satisfied: 2.20<BL/ImgH<3.50. Therefore, it is favorable for balancing the ratio between the back focal length and the image height to reduce distortion in the imaging lens system. Moreover, the following condition can also be satisfied: 2.50<BL/ImgH<3.20.

When an axial distance between the object-side surface of the first lens element and the image surface is TL, and the maximum image height of the imaging lens system is ImgH, the following condition can be satisfied: 4.00<TL/ImgH<7.00. Therefore, it is favorable for maintaining an appropriate ratio between the image height and the total length of the imaging lens system to ensure sufficient image brightness while pursuing the miniaturization of the imaging lens system. Moreover, the following condition can also be satisfied: 4.50<TL/ImgH<6.50. Moreover, the following condition can also be satisfied: 5.00<TL/ImgH<5.80.

When a focal length of the first lens element is f1, and a focal length of the second lens element is f2, the following condition can be satisfied: 0.50<|f1/f2|<1.50. Therefore, it is favorable for the refractive power of the first lens element and the second lens element to be coordinated for correcting aberrations. Moreover, the following condition can also be satisfied: 0.60<|f1/f2|<1.20.

When the focal length of the first lens element is f1, and the focal length of the third lens element is f3, the following condition can be satisfied: 0.40<f1/f3<1.50. Therefore, it is favorable for balancing the light-converging capability at the object-side end of the imaging lens system. Moreover, the following condition can also be satisfied: 0.60<f1/f3<1.35.

When the focal length of the first lens element is f1, the focal length of the second lens element is f2, a focal length of the fourth lens element is f4, and a focal length of the fifth lens element is f5, the following condition can be satisfied: −0.60<(f1+f2)/(f4+f5)<5.00. Therefore, it is favorable for balancing the refractive power configuration of the imaging lens system to enhance image quality. Moreover, the following condition can also be satisfied: −0.50<(f1+f2)/(f4+f5)<4.00. Moreover, the following condition can also be satisfied: −0.40<(f1+f2)/(f4+f5)<3.00.

When a curvature radius of the object-side surface of the fifth lens element is R9, and the curvature radius of the image-side surface of the fifth lens element is R10, the following condition can be satisfied: −1.80<R9/R10<1.00. Therefore, it is favorable for adjusting the refractive power and surface shape of the fifth lens element to correct off-axis aberrations in the imaging lens system. Moreover, the following condition can also be satisfied: −1.60<R9/R10<0.80.

When a curvature radius of the image-side surface of the third lens element is R6, and a curvature radius of the object-side surface of the fourth lens element is R7, the following condition can be satisfied: −1.00<R6/R7<1.10. Therefore, it is favorable for adjusting the curvature radii of the two adjacent lens surfaces of the third lens element and the fourth lens element to reduce chromatic aberration in the peripheral field of view. Moreover, the following condition can also be satisfied: −0.90<R6/R7<1.00. Moreover, the following condition can also be satisfied: −0.80<R6/R7<0.90.

When an axial distance between the image-side surface of the first lens element and the object-side surface of the third lens element is Dr2r5, and an axial distance between the image-side surface of the fourth lens element and the image-side surface of the fifth lens element is Dr8r10, the following condition can be satisfied: 0.00<Dr2r5/Dr8r10<1.70. Therefore, it is favorable for ensuring that the imaging lens system has an appropriate distance between lens elements, thereby facilitating lens assembly and device size adjustment. Moreover, the following condition can also be satisfied: 0.30<Dr2r5/Dr8r10<1.50.

When an Abbe number of the second lens element is V2, the following condition can be satisfied: 5.0<V2<35.0. Therefore, it is favorable for correcting chromatic aberration in the imaging lens system, preventing image overlap and enhancing image quality. Moreover, the following condition can also be satisfied: 10.0<V2<30.0.

When an Abbe number of the third lens element is V3, the following condition can be satisfied: 45.0<V3<70.0. Therefore, it is favorable for selecting low-dispersion lens material to balance the convergence capability of light in different wavelength bands. Moreover, the following condition can also be satisfied: 50.0<V3<60.0.

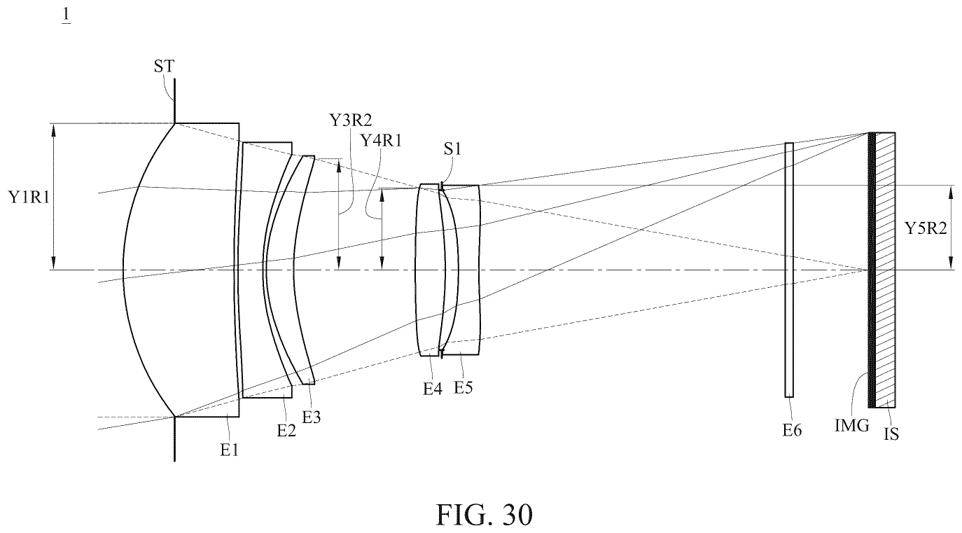

When a maximum effective radius of the image-side surface of the third lens element is Y3R2, and a maximum effective radius of the object-side surface of the fourth lens element is Y4R1, the following condition can be satisfied: 1.20<Y3R2/Y4R1<1.90. Therefore, it is favorable for reducing the size of the image-side end of the imaging lens system to facilitate the miniaturization of the imaging lens system. Moreover, the following condition can also be satisfied: 1.30<Y3R2/Y4R1<1.75. Please refer to FIG. 30, which shows a schematic view of Y3R2 and Y4R1 according to the 1st embodiment of the present disclosure.

When a maximum field of view of the imaging lens system is FOV, the following condition can be satisfied: 10.0 degrees<FOV<25.0 degrees. Therefore, it is favorable for capturing distant images to enhance local image resolution, thereby achieving a telephoto effect. Moreover, the following condition can also be satisfied: 13.0 degrees<FOV<23.0 degrees.

When the axial distance between the image-side surface of the fifth lens element and the image surface is BL, and the axial distance between the third lens element and the fourth lens element is T34, the following condition can be satisfied: 1.00<BL/T34<4.50. Therefore, it is favorable for adjusting the ratio of the back focal length of the imaging lens system to the axial distance between the third lens element and the fourth lens element for the imaging lens system to achieve a telephoto configuration. Moreover, the following condition can also be satisfied: 1.50<BL/T34<4.50.

When a curvature radius of the image-side surface of the first lens element is R2, and a curvature radius of the object-side surface of the second lens element is R3, the following condition can be satisfied: 0.00<|R3/R2|<1.10. Therefore, it is favorable for controlling the refraction angle of light within the imaging lens system to enhance peripheral image illuminance. Moreover, the following condition can also be satisfied: 0.00<|R3/R2|<1.00. Moreover, the following condition can also be satisfied: 0.00<|R3/R2|<0.90.

When a curvature radius of the object-side surface of the third lens element is R5, and the curvature radius of the image-side surface of the third lens element is R6, the following condition can be satisfied: −0.50<(R5−R6)/(R5+R6)<1.00. Therefore, it is favorable for adjusting the refractive power and surface shape of the third lens element, thereby correcting aberrations. Moreover, the following condition can also be satisfied: −0.50<(R5−R6)/(R5+R6)<0.50. Moreover, the following condition can also be satisfied: −0.40<(R5-R6)/(R5+R6)<0.10.

When a central thickness of the first lens element is CT1, and a central thickness of the second lens element is CT2, the following condition can be satisfied: 2.00<CT1/CT2<5.50. Therefore, it is favorable for balancing the central thickness ratio of the first lens element and the second lens element to enhance the structural stability of the imaging lens system. Moreover, the following condition can also be satisfied: 2.50<CT1/CT2<5.00.

When the axial distance between the image-side surface of the fifth lens element and the image surface is BL, and a sum of axial distances between each of all adjacent lens elements of the imaging lens system is ΣAT, the following condition can be satisfied: 1.70<BL/ΣAT<3.80. Therefore, it is favorable for adjusting the spatial arrangement of the lens elements, thereby enabling the imaging lens system to achieve a telephoto effect. Moreover, the following condition can also be satisfied: 1.80<BL/ΣAT<3.50.

When the axial distance between the third lens element and the fourth lens element is T34, and the axial distance between the object-side surface of the first lens element and the image-side surface of the third lens element is Dr1r6, the following condition can be satisfied: 0.50<T34/Dr1r6<1.60. Therefore, it is favorable for reducing the size of the object-side end of the imaging lens system. Moreover, the following condition can also be satisfied: 0.50<T34/Dr1r6<1.30.

When a maximum effective radius of the object-side surface of the first lens element is Y1R1, and a maximum effective radius of the image-side surface of the fifth lens element is Y5R2, the following condition can be satisfied: 1.60<Y1R1/Y5R2<3.50. Therefore, it is favorable for adjusting the ratio of the optical effective radius between the first lens element and the fifth lens element to reduce the incident angle of light on the image surface and enhance illuminance. Moreover, the following condition can also be satisfied: 1.60<Y1R1/Y5R2<2.50. Please refer to FIG. 30, which shows a schematic view of Y1R1 and Y5R2 according to the 1st embodiment of the present disclosure.

According to the present disclosure, the aforementioned features and conditions can be utilized in numerous combinations so as to achieve corresponding effects.

According to the present disclosure, the lens elements of the imaging lens system can be made of either glass or plastic material. When the lens elements are made of glass material, the refractive power distribution of the imaging lens system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the imaging lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis. Please refer to FIG. 29, which shows a schematic view of the critical points C on the lens surfaces according to the 1st embodiment of the present disclosure. In FIG. 29, the image-side surface of the fifth lens element E5 has one critical point C in an off-axis region thereof. The 1st embodiment of the present disclosure shown in FIG. 29 is only exemplary. Each of the lens surfaces of the lens elements in various embodiments of the present disclosure can have one or more critical points in an off-axis region thereof.

According to the present disclosure, the image surface of the imaging lens system, based on the corresponding image sensor, can be flat or curved, especially a curved surface being concave facing towards the object side of the imaging lens system.

According to the present disclosure, an image correction unit, such as a field flattener, can be optionally disposed between the lens element closest to the image side of the imaging lens system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

According to the present disclosure, the imaging lens system can include at least one stop, such as an aperture stop, a glare stop or a field stop. Said glare stop or said field stop can be disposed between an imaged object and the first lens element, between adjacent lens elements, or between the last lens element and the image surface, and is set for eliminating the stray light and thereby improving image quality thereof.

According to the present disclosure, an aperture stop can be configured as a front stop or a middle stop. Afront stop disposed between an imaged object and the first lens element can provide a longer distance between an exit pupil of the imaging lens system and the image surface to produce a telecentric effect, and thereby improves the image-sensing efficiency of an image sensor (for example, CCD or CMOS). A middle stop disposed between the first lens element and the image surface is favorable for enlarging the viewing angle of the imaging lens system and thereby provides a wider field of view for the same.

According to the present disclosure, the imaging lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the imaging lens system can include one or more optical elements for limiting the form of light passing through the imaging lens system. Each optical element can be, but not limited to, a filter, a polarizer, etc., and each optical element can be, but not limited to, a single-piece element, a composite component, a thin film, etc. The optical element can be located at the object side or the image side of the imaging lens system or between any two adjacent lens elements so as to allow light in a specific form to pass through, thereby meeting application requirements.

According to the present disclosure, the imaging lens system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the imaging lens system can further include a light-blocking element. The light-blocking element can have a non-circular opening, and the non-circular opening can have different effective radii in different directions which are perpendicular to the optical axis. Therefore, it is favorable for the light-blocking element to coordinate with the shape of non-circular lens elements or aperture stop so as to reduce the size of the imaging lens system and make full use of the light passing through said non-circular lens elements or aperture stop, thereby reducing stray light. Moreover, the light-blocking element can be provided with a wavy structure or a jagged structure at a periphery of an inner hole portion thereof.

According to the present disclosure, the object side and image side are defined in accordance with the direction of the optical axis, and the axial optical data are calculated along the optical axis. Furthermore, if the optical axis is deflected by a reflective element, the axial optical data are also calculated along the deflected optical axis.

According to the above description of the present disclosure, the following specific embodiments are provided for further explanation.

### 1st Embodiment

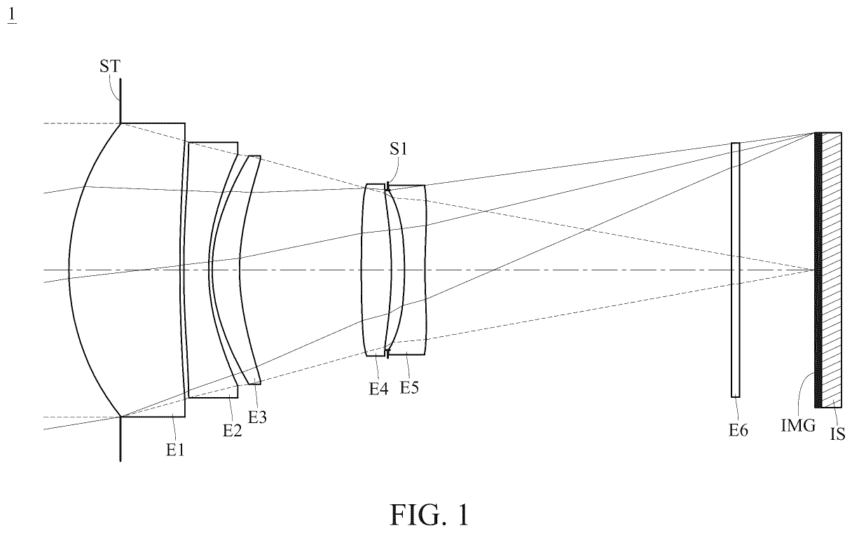

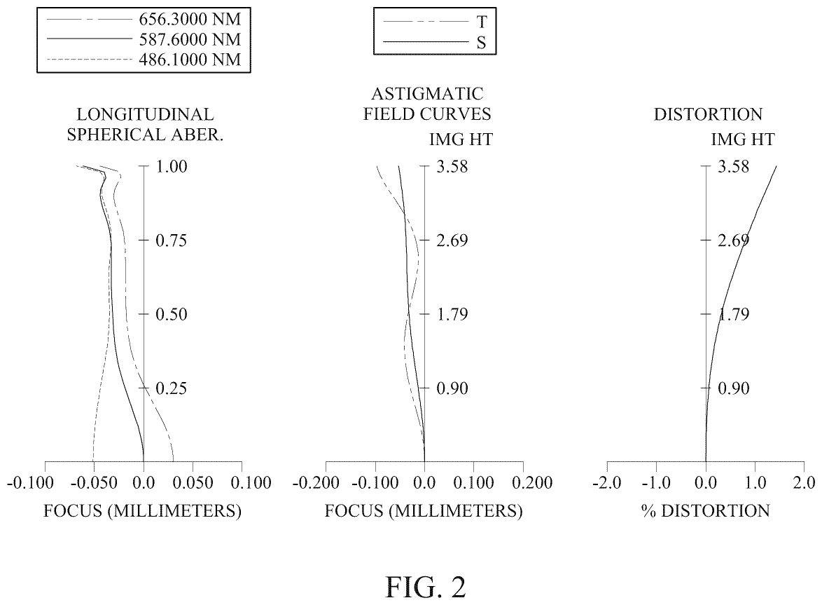

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The image-side surface of the fourth lens element E4 has one inflection point.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point. The image-side surface of the fifth lens element E5 has one critical point in an off-axis region thereof.

The filter E6 is made of glass material and located between the fifth lens element E5 and the image surface IMG, and will not affect the focal length of the imaging lens system. The image sensor IS is disposed on or near the image surface IMG of the imaging lens system.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12 and 14.

In the imaging lens system of the image capturing unit 1 according to the 1st embodiment, when a focal length of the imaging lens system is f, an f-number of the imaging lens system is Fno, and half of a maximum field of view of the imaging lens system is HFOV, these parameters have the following values: f=21.72 millimeters (mm), Fno=2.83, and HFOV=9.3 degrees (deg.).

When the maximum field of view of the imaging lens system is FOV, the following condition is satisfied: FOV=18.6 degrees.

When an axial distance between the object-side surface of the first lens element E1 and the image surface IMG is TL, and a maximum image height of the imaging lens system is ImgH, the following condition is satisfied: TL/ImgH=5.43.

When an axial distance between the image-side surface of the fifth lens element E5 and the image surface IMG is BL, and the maximum image height of the imaging lens system is ImgH, the following condition is satisfied: BL/ImgH=2.84.

When an axial distance between the object-side surface of the first lens element E1 and the image-side surface of the fifth lens element E5 is TD, and the axial distance between the image-side surface of the fifth lens element E5 and the image surface IMG is BL, the following condition is satisfied: TD/BL=0.91.

When the axial distance between the image-side surface of the fifth lens element E5 and the image surface IMG is BL, and an axial distance between the third lens element E3 and the fourth lens element E4 is T34, the following condition is satisfied: BL/T34=3.20. In this embodiment, an axial distance between two adjacent lens elements is a distance in a paraxial region between two adjacent lens surfaces of the two adjacent lens elements.

When the axial distance between the image-side surface of the fifth lens element E5 and the image surface IMG is BL, and a sum of axial distances between each of all adjacent lens elements of the imaging lens system is ΣAT, the following condition is satisfied: BL/ΣAT=2.74. In this embodiment, ΣAT represents a sum of axial distances between any two adjacent lens elements among the first lens element E1, the second lens element E2, the third lens element E3, the fourth lens element E4 and the fifth lens element E5.

When the focal length of the imaging lens system is f, and a focal length of the third lens element E3 is f3, the following condition is satisfied: f/f3=0.89.

When a focal length of the first lens element E1 is f1, and a focal length of the second lens element E2 is f2, the following condition is satisfied: |f1/f2|=0.98.

When the focal length of the first lens element E1 is f1, and the focal length of the third lens element E3 is f3, the following condition is satisfied: f1/f3=0.49.

When the focal length of the first lens element E1 is f1, the focal length of the second lens element E2 is f2, a focal length of the fourth lens element E4 is f4, and a focal length of the fifth lens element E5 is f5, the following condition is satisfied: (f1+f2)/(f4+f5)=−0.12.

When an axial distance between the object-side surface of the first lens element E1 and the image-side surface of the third lens element E3 is Dr1r6, and an axial distance between the object-side surface of the fourth lens element E4 and the image-side surface of the fifth lens element E5 is Dr7r10, the following condition is satisfied: Dr1r6/Dr7r10=2.68.

When an axial distance between the image-side surface of the first lens element E1 and the object-side surface of the third lens element E3 is Dr2r5, and an axial distance between the image-side surface of the fourth lens element E4 and the image-side surface of the fifth lens element E5 is Dr8r10, the following condition is satisfied: Dr2r5/Dr8r10=0.96.

When a curvature radius of the image-side surface of the first lens element E1 is R2, and a curvature radius of the object-side surface of the second lens element E2 is R3, the following condition is satisfied: |R3/R21=0.57.

When a curvature radius of the image-side surface of the second lens element E2 is R4, and a curvature radius of the image-side surface of the fifth lens element E5 is R10, the following condition is satisfied: |R4/R10|=0.40.

When a curvature radius of the image-side surface of the third lens element E3 is R6, and a curvature radius of the object-side surface of the fourth lens element E4 is R7, the following condition is satisfied: R6/R7=0.14.

When a curvature radius of the object-side surface of the fifth lens element E5 is R9, and the curvature radius of the image-side surface of the fifth lens element E5 is R10, the following condition is satisfied: R9/R10=−0.63.

When a curvature radius of the object-side surface of the third lens element E3 is R5, and the curvature radius of the image-side surface of the third lens element E3 is R6, the following condition is satisfied: (R5-R6)/(R5+R6)=−0.16.

When a central thickness of the first lens element E1 is CT1, and a central thickness of the second lens element E2 is CT2, the following condition is satisfied: CT1/CT2=4.46.

When an axial distance between the first lens element E1 and the second lens element E2 is T12, an axial distance between the second lens element E2 and the third lens element E3 is T23, the axial distance between the third lens element E3 and the fourth lens element E4 is T34, and an axial distance between the fourth lens element E4 and the fifth lens element E5 is T45, the following condition is satisfied: (T12+T23+T45)/T34=0.17.

When the axial distance between the second lens element E2 and the third lens element E3 is T23, and the axial distance between the fourth lens element E4 and the fifth lens element E5 is T45, the following condition is satisfied: T23/T45=0.27.

When the axial distance between the third lens element E3 and the fourth lens element E4 is T34, and the axial distance between the object-side surface of the first lens element E1 and the image-side surface of the third lens element E3 is Dr1r6, the following condition is satisfied: T34/Dr1r6=0.71.

When an Abbe number of the second lens element E2 is V2, the following condition is satisfied: V2=25.6.

When an Abbe number of the third lens element E3 is V3, the following condition is satisfied: V3=56.0.

When an Abbe number of the fourth lens element E4 is V4, the following condition is satisfied: V4=16.3.

When a maximum effective radius of the image-side surface of the third lens element E3 is Y3R2, and a maximum effective radius of the object-side surface of the fourth lens element E4 is Y4R1, the following condition is satisfied: Y3R2/Y4R1=1.31.

When a maximum effective radius of the object-side surface of the first lens element E1 is Y1R1, and a maximum effective radius of the image-side surface of the fifth lens element E5 is Y5R2, the following condition is satisfied: Y1R1/Y5R2=1.73.

The detailed optical data of the 1st embodiment are shown in Table 1A and the aspheric surface data are shown in Table 1B below.

TABLE 1A
1st Embodiment
f = 21.72 mm, Fno = 2.83, HFOV = 9.3 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −1.346 | | | | |
| 2 | Lens 1 | 6.0726 | (SPH) | 2.900 | Glass | 1.569 | 63.0 | 12.00 |
| 3 | | 45.3907 | (SPH) | 0.100 | | | | |
| 4 | Lens 2 | 25.7146 | (ASP) | 0.650 | Plastic | 1.614 | 25.6 | −12.28 |
| 5 | | 5.7710 | (ASP) | 0.091 | | | | |
| 6 | Lens 3 | 4.2196 | (ASP) | 0.714 | Plastic | 1.544 | 56.0 | 24.53 |
| 7 | | 5.8023 | (ASP) | 3.179 | | | | |
| 8 | Lens 4 | 41.9350 | (ASP) | 0.783 | Plastic | 1.697 | 16.3 | 10.82 |
| 9 | | −9.1301 | (ASP) | −0.093 | | | | |
| 10 | Stop | Plano | | 0.436 | | | | |
| 11 | Lens 5 | −8.9286 | (ASP) | 0.535 | Plastic | 1.639 | 23.5 | −8.53 |
| 12 | | 14.2857 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 1.969 | | | | |
| 15 | Image | Plano | — | | | | |

Note:
Reference wavelength is 587.6 nm (d-line).
An effective radius of the stop S1 (Surface 10) is 2.087 mm.

TABLE 1B
Aspheric Coefficients

| Surface # | 4 | 5 | 6 | 7 |
|---|---|---|---|---|
| k= | 0.00000E+00 | 1.58199E+00 | 0.00000E+00 | 0.00000E+00 |
| A4= | 8.540477E−04 | 3.189483E−03 | 6.997202E−04 | −3.517906E−03 |
| A6= | −4.413465E−04 | −2.086325E−03 | −1.919142E−03 | −3.123578E−04 |
| A8= | 4.870163E−05 | 3.141312E−04 | 3.447681E−04 | 9.964352E−05 |
| A10= | −2.605498E−06 | −2.449633E−05 | −2.678678E−05 | −7.849789E−06 |
| A12= | 5.925464E−08 | 7.328978E−07 | 7.056543E−07 | 9.733522E−08 |
| Surface # | 8 | 9 | 11 | 12 |
| k= | 0.00000E+00 | 0.00000E+00 | 0.00000E+00 | 0.00000E+00 |
| A4= | 2.202496E−03 | 1.084403E−02 | 1.241905E−03 | −8.145790E−03 |
| A6= | −1.058312E−03 | −5.975341E−03 | −8.291521E−03 | −9.689550E−04 |
| A8= | 2.593551E−04 | 1.950604E−03 | 3.383463E−03 | 4.771420E−04 |
| A10= | 3.635033E−05 | −3.112302E−04 | −8.324478E−04 | −7.785945E−05 |
| A12= | −1.673579E−05 | 1.741480E−05 | 1.130718E−04 | 6.035484E−06 |
| A14= | 1.791490E−06 | 8.463200E−07 | −6.506085E−06 | −1.929595E−07 |

In Table 1A, the curvature radius, the thickness and the focal length are shown in millimeters (mm). Surface numbers 0-15 represent the surfaces sequentially arranged from the object side to the image side along the optical axis. In Table 1B, k represents the conic coefficient of the equation of the aspheric surface profiles. A4-A14 represent the aspheric coefficients ranging from the 4th order to the 14th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

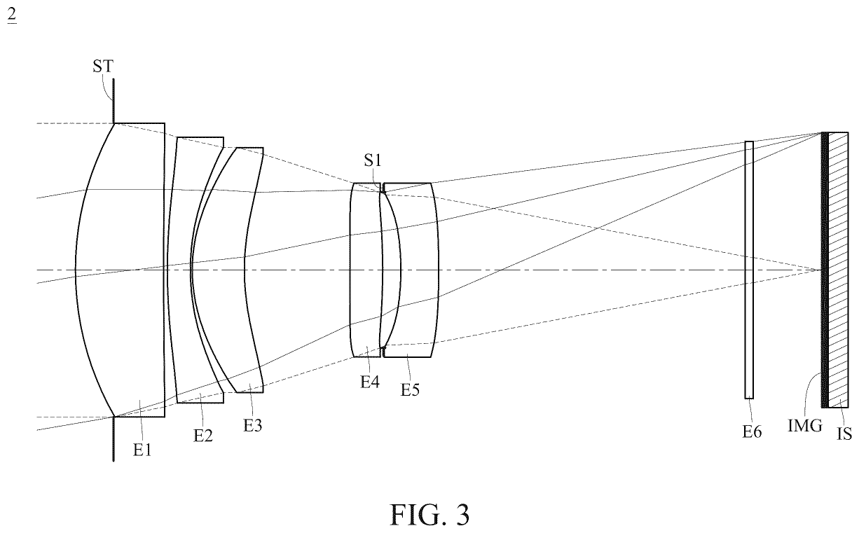

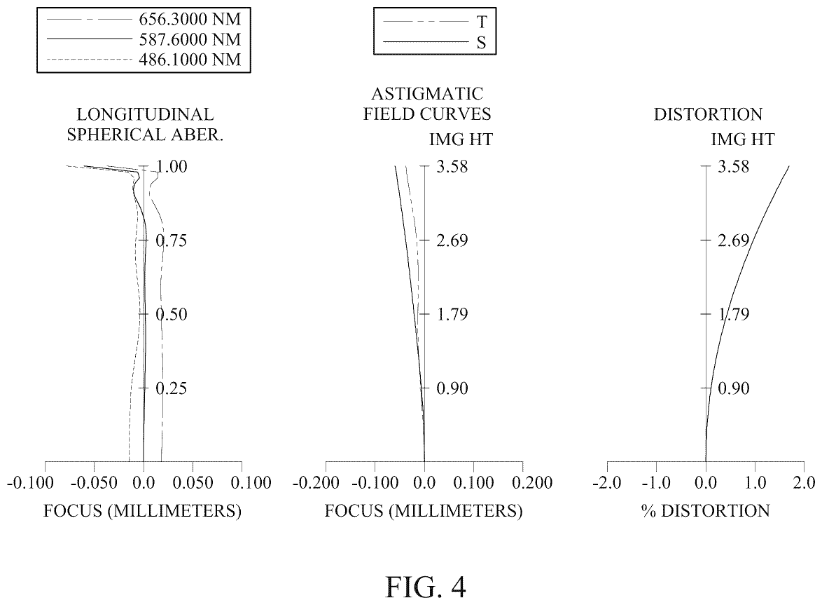

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 2nd embodiment are shown in Table 2A and the aspheric surface data are shown in Table 2B below.

TABLE 2A
2nd Embodiment
f = 20.56 mm, Fno = 2.68, HFOV = 9.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.994 | | | | |
| 2 | Lens 1 | 7.6807 | (SPH) | 2.300 | Glass | 1.572 | 57.5 | 13.89 |
| 3 | | 201.7186 | (SPH) | 0.100 | | | | |
| 4 | Lens 2 | 17.0154 | (ASP) | 0.599 | Plastic | 1.615 | 25.4 | −14.45 |
| 5 | | 5.7563 | (ASP) | 0.050 | | | | |
| 6 | Lens 3 | 4.1569 | (ASP) | 1.361 | Plastic | 1.544 | 56.0 | 19.21 |
| 7 | | 6.1056 | (ASP) | 2.756 | | | | |
| 8 | Lens 4 | −271.9955 | (ASP) | 0.852 | Plastic | 1.697 | 16.3 | 24.19 |
| 9 | | −15.9005 | (ASP) | 0.018 | | | | |
| 10 | Stop | Plano | | 0.457 | | | | |
| 11 | Lens 5 | −6.7953 | (ASP) | 0.988 | Plastic | 1.587 | 28.3 | −16.16 |
| 12 | | −25.2301 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 1.789 | | | | |
| 15 | Image | Plano | — | | | | |

Note:
Reference wavelength is 587.6 nm (d-line).
An effective radius of the stop S1 (Surface 10) is 2.035 mm.

TABLE 2B
Aspheric Coefficients

| Surface # | 4 | 5 | 6 | 7 |
|---|---|---|---|---|
| k= | 0.00000E+00 | 1.57880E+00 | 0.00000E+00 | 0.00000E+00 |
| A4= | 1.223659E−04 | −2.324373E−03 | −3.471701E−03 | −2.904911E−03 |
| A6= | −3.489094E−05 | 5.741695E−04 | 6.260968E−04 | −2.863654E−04 |
| A8= | −1.522560E−05 | −1.727328E−04 | −1.703163E−04 | 1.127581E−05 |
| A10= | 1.482684E−06 | 1.572755E−05 | 1.688681E−05 | 4.202644E−06 |
| A12= | −3.713159E−08 | −5.275758E−07 | −5.874150E−07 | −3.387307E−07 |
| Surface # | 8 | 9 | 11 | 12 |
| k= | 0.00000E+00 | 0.00000E+00 | 0.00000E+00 | 0.00000E+00 |
| A4= | 3.354537E−03 | 6.810248E−03 | 6.143528E−05 | −2.336419E−03 |
| A6= | −1.372920E−03 | −3.294558E−03 | −4.530421E−03 | −1.093584E−03 |
| A8= | 1.893745E−04 | 2.275637E−04 | 7.367664E−04 | 2.591834E−04 |
| A10= | 5.446872E−05 | 2.224956E−04 | 2.871074E−05 | −1.158012E−05 |
| A12= | −7.720576E−06 | −5.081849E−05 | −1.329842E−05 | −3.351883E−06 |
| A14= | 2.514474E−07 | 4.713444E−06 | 5.560128E−07 | 2.648727E−07 |

In the 2nd embodiment, the equation of the aspheric surface profiles of the aforementioned lens elements is the same as the equation of the 1st embodiment. Also, the definitions of these parameters shown in Table 20 below are the same as those stated in the 1st embodiment, with corresponding values for the 2nd embodiment; therefore, an explanation in this regard will not be provided again.

Moreover, these parameters can be calculated from Table 2A and Table 2B as the following values and satisfy the following conditions:

TABLE 2C
Values of Optical and Physical Parameters/Definitions

| | | | |
|---|---|---|---|
| f [mm] | 20.56 | \|R3/R2\| | 0.08 |
| Fno | 2.68 | \|R4/R10\| | 0.23 |
| HFOV [deg.] | 9.7 | R6/R7 | −0.02 |
| FOV [deg.] | 19.4 | R9/R10 | 0.27 |
| TL/ImgH | 5.44 | (R5 − R6)/(R5 + R6) | −0.19 |
| BL/ImgH | 2.79 | CT1/CT2 | 3.84 |
| TD/BL | 0.95 | (T12 + T23 + T45)/T34 | 0.23 |
| BL/T34 | 3.63 | T23/T45 | 0.11 |
| BL/ΣAT | 2.96 | T34/Dr1r6 | 0.62 |
| f/f3 | 1.07 | V2 | 25.4 |
| \|f1/f2\| | 0.96 | V3 | 56.0 |
| f1/f3 | 0.72 | V4 | 16.3 |
| (f1 + f2)/(f4 + f5) | −0.07 | Y3R2/Y4R1 | 1.32 |
| Dr1r6/Dr7r10 | 1.90 | Y1R1/Y5R2 | 1.69 |
| Dr2r5/Dr8r10 | 0.51 | — | — |

### 3rd Embodiment

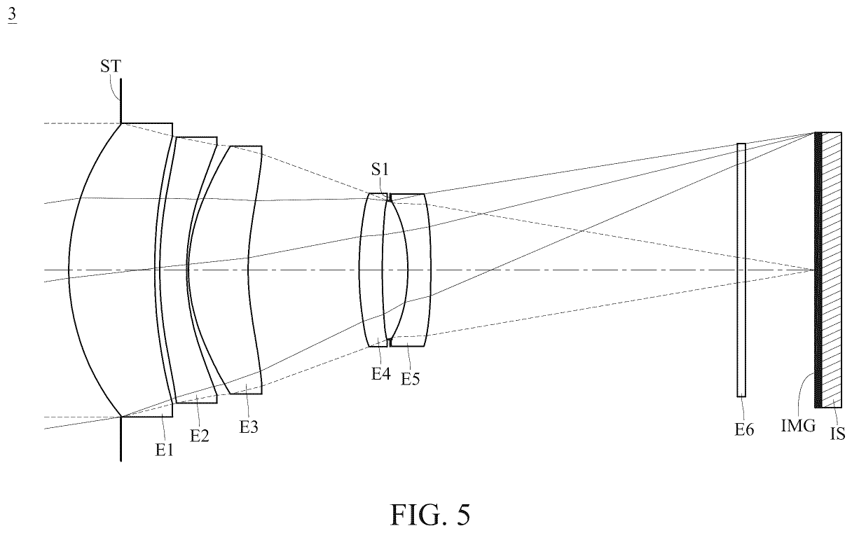

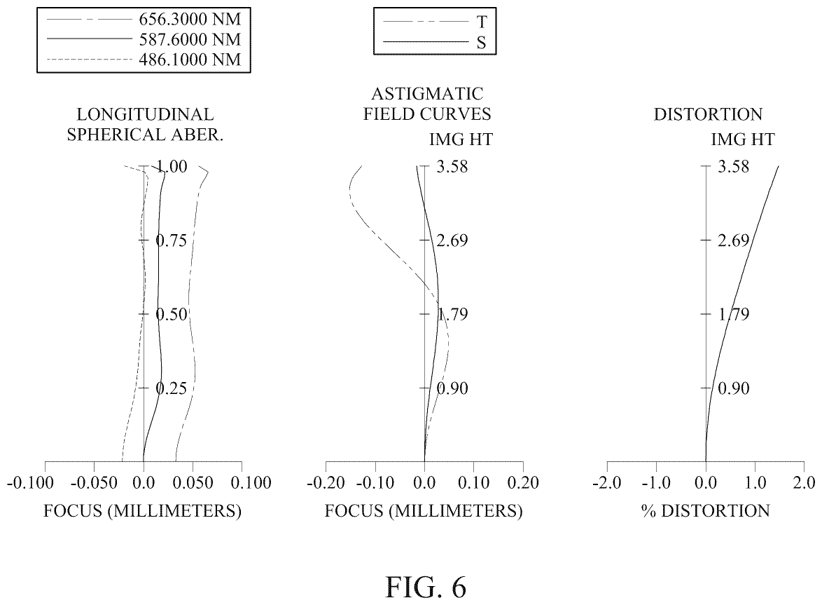

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being convex in a paraxial region thereof and an image-side surface being concave in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 3rd embodiment are shown in Table 3A and the aspheric surface data are shown in Table 3B below.

TABLE 3A
3rd Embodiment
f = 22.80 mm, Fno = 2.97, HFOV = 8.8 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −1.364 | | | | |
| 2 | Lens 1 | 6.0045 | (SPH) | 2.240 | Glass | 1.487 | 70.4 | 20.43 |
| 3 | | 13.2744 | (SPH) | 0.137 | | | | |
| 4 | Lens 2 | 11.0641 | (ASP) | 0.700 | Plastic | 1.669 | 19.5 | −20.51 |
| 5 | | 5.9704 | (ASP) | 0.050 | | | | |
| 6 | Lens 3 | 4.3057 | (ASP) | 1.556 | Plastic | 1.544 | 56.0 | 16.47 |
| 7 | | 7.2330 | (ASP) | 2.896 | | | | |
| 8 | Lens 4 | 8.9824 | (ASP) | 0.605 | Plastic | 1.669 | 19.5 | 22.98 |
| 9 | | 21.0181 | (ASP) | 0.204 | | | | |
| 10 | Stop | Plano | | 0.464 | | | | |
| 11 | Lens 5 | −4.6974 | (ASP) | 0.600 | Plastic | 1.544 | 56.0 | −11.44 |
| 12 | | −20.0346 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 1.817 | | | | |
| 15 | Image | Plano | — | | | | |

Note:
Reference wavelength is 587.6 nm (d-line).
An effective radius of the stop S1 (Surface 10) is 1.810 mm.

TABLE 3B
Aspheric Coefficients

| Surface # | 4 | 5 | 6 | 7 |
|---|---|---|---|---|
| k= | 0.00000E+00 | 1.55129E+00 | 0.00000E+00 | 0.00000E+00 |
| A4= | −5.721640E−04 | −2.992110E−03 | −2.926580E−03 | −2.039730E−03 |
| A6= | 1.911840E−04 | 7.415100E−04 | 4.142010E−04 | −6.866730E−04 |
| A8= | −3.753740E−05 | −1.708390E−04 | −1.419250E−04 | 8.029250E−05 |
| A10= | 2.022430E−06 | 1.335820E−05 | 1.521520E−05 | −1.270860E−06 |
| A12= | −3.261380E−08 | −4.101320E−07 | −5.615200E−07 | −1.531030E−07 |
| Surface # | 8 | 9 | 11 | 12 |
| k= | 0.00000E+00 | 0.00000E+00 | 0.00000E+00 | 0.00000E+00 |
| A4= | 5.504860E−03 | 1.126620E−02 | 2.430950E−03 | −1.106060E−03 |
| A6= | −5.226560E−03 | −9.343310E−03 | −7.696090E−03 | −3.068840E−03 |
| A8= | 1.839840E−03 | 3.639850E−03 | 2.731650E−03 | 1.006370E−03 |
| A10= | −3.652740E−04 | −8.069980E−04 | −6.871250E−04 | −1.335950E−04 |
| A12= | 6.396020E−05 | 1.191390E−04 | 1.387900E−04 | 1.036890E−06 |
| A14= | −4.641440E−06 | −3.273520E−06 | −1.396560E−05 | 3.644140E−07 |

In the 3rd embodiment, the equation of the aspheric surface profiles of the aforementioned lens elements is the same as the equation of the 1st embodiment. Also, the definitions of these parameters shown in Table 30 below are the same as those stated in the 1st embodiment, with corresponding values for the 3rd embodiment; therefore, an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| f [mm] | 22.80 | \|R3/R2\| | 0.83 |
| Fno | 2.97 | \|R4/R10\| | 0.30 |
| HFOV [deg.] | 8.8 | R6/R7 | 0.81 |
| FOV [deg.] | 17.6 | R9/R10 | 0.23 |
| TL/ImgH | 5.44 | (R5 − R6)/(R5 + R6) | −0.25 |
| BL/ImgH | 2.80 | CT1/CT2 | 3.20 |
| TD/BL | 0.94 | (T12 + T23 + T45)/T34 | 0.30 |
| BL/T34 | 3.46 | T23/T45 | 0.07 |
| BL/ΣAT | 2.67 | T34/Dr1r6 | 0.62 |
| f/f3 | 1.38 | V2 | 19.5 |
| \|f1/f2\| | 1.00 | V3 | 56.0 |
| f1/f3 | 1.24 | V4 | 19.5 |
| (f1 + f2)/(f4 + f5) | −0.01 | Y3R2/Y4R1 | 1.50 |
| Dr1r6/Dr7r10 | 2.50 | Y1R1/Y5R2 | 1.93 |
| Dr2r5/Dr8r10 | 0.70 | — | — |

### 4th Embodiment

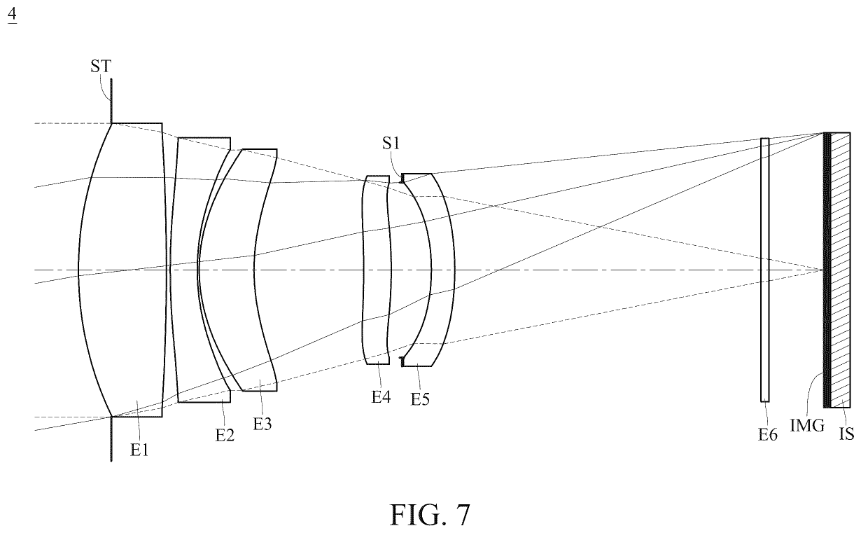

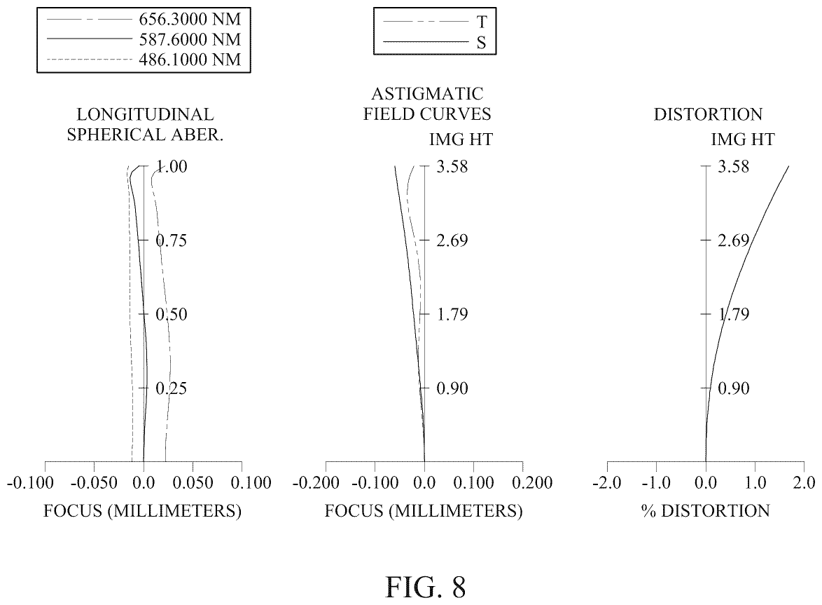

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 4th embodiment are shown in Table 4A and the aspheric surface data are shown in Table 4B below.

TABLE 4A
4th Embodiment
f = 20.00 mm, Fno = 2.61, HFOV = 10.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.857 | | | | |
| 2 | Lens 1 | 8.8158 | (SPH) | 2.300 | Glass | 1.617 | 53.9 | 12.54 |
| 3 | | −57.1668 | (SPH) | 0.100 | | | | |
| 4 | Lens 2 | 18.9726 | (ASP) | 0.706 | Plastic | 1.616 | 25.3 | −13.53 |
| 5 | | 5.7052 | (ASP) | 0.050 | | | | |
| 6 | Lens 3 | 4.1572 | (ASP) | 1.433 | Plastic | 1.544 | 56.0 | 25.14 |
| 7 | | 5.2476 | (ASP) | 2.863 | | | | |
| 8 | Lens 4 | −26.3420 | (ASP) | 0.722 | Plastic | 1.650 | 21.8 | 32.83 |
| 9 | | −11.9127 | (ASP) | 0.278 | | | | |
| 10 | Stop | Plano | | 0.770 | | | | |
| 11 | Lens 5 | −5.1278 | (ASP) | 0.611 | Plastic | 1.562 | 44.6 | −28.36 |
| 12 | | −7.8858 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 1.436 | | | | |
| 15 | Image | Plano | — | | | | |

Note:
Reference wavelength is 587.6 nm (d-line).
An effective radius of the stop S1 (Surface 10) is 2.287 mm.

TABLE 4B
Aspheric Coefficients

| Surface # | 4 | 5 | 6 | 7 |
|---|---|---|---|---|
| k = | 0.00000E+00 | 1.58654E+00 | 0.00000E+00 | 0.00000E+00 |
| A4 = | 9.695438E−04 | −1.689447E−04 | −3.349104E−03 | −5.065665E−03 |
| A6 = | −4.083488E−04 | −4.519392E−04 | 1.689641E−04 | 2.424714E−04 |
| A8 = | 3.496333E−05 | 5.463477E−06 | −1.701106E−05 | 3.064818E−05 |
| A10 = | −1.347484E−06 | 1.657499E−06 | 5.672507E−08 | −8.100809E−06 |
| A12 = | 2.272839E−08 | −8.562112E−08 | 9.835889E−09 | 3.154941E−07 |
| Surface # | 8 | 9 | 11 | 12 |
| k = | 0.00000E+00 | 0.00000E+00 | 0.00000E+00 | 0.00000E+00 |
| A4 = | −1.209367E−03 | −1.319552E−03 | −7.611872E−03 | −5.233598E−03 |
| A6 = | 7.749043E−04 | 9.489448E−04 | 8.830422E−04 | 8.139187E−04 |
| A8 = | 2.700645E−04 | 2.478622E−04 | −1.395195E−04 | −3.076350E−04 |
| A10 = | −7.544313E−05 | −6.745748E−05 | −3.566433E−05 | 5.380728E−05 |
| A12 = | 9.459167E−06 | 8.237024E−06 | 1.242472E−05 | −4.644689E−06 |
| A14 = | −4.551283E−07 | −2.002773E−07 | −1.105385E−06 | 1.179682E−07 |

In the 4th embodiment, the equation of the aspheric surface profiles of the aforementioned lens elements is the same as the equation of the 1st embodiment. Also, the definitions of these parameters shown in Table 40 below are the same as those stated in the 1st embodiment, with corresponding values for the 4th embodiment; therefore, an explanation in this regard will not be provided again.

Moreover, these parameters can be calculated from Table 4A and Table 4B as the following values and satisfy the following conditions:

TABLE 4C
Values of Optical and Physical Parameters/Definitions

| | | | |
|---|---|---|---|
| f [mm] | 20.00 | \|R3/R2\| | 0.33 |
| Fno | 2.61 | \|R4/R10\| | 0.72 |
| HFOV [deg.] | 10.0 | R6/R7 | −0.20 |
| FOV [deg.] | 20.0 | R9/R10 | 0.65 |
| TL/ImgH | 5.43 | (R5 − R6)/(R5 + R6) | −0.12 |
| BL/ImgH | 2.69 | CT1/CT2 | 3.26 |
| TD/BL | 1.02 | (T12 + T23 + T45)/T34 | 0.42 |
| BL/T34 | 3.37 | T23/T45 | 0.05 |
| BL/ΣAT | 2.38 | T34/Dr1r6 | 0.62 |
| f/f3 | 0.80 | V2 | 25.3 |
| \|f1/f2\| | 0.93 | V3 | 56.0 |
| f1/f3 | 0.50 | V4 | 21.8 |
| (f1 + f2)/(f4 + f5) | −0.22 | Y3R2/Y4R1 | 1.24 |
| Dr1r6/Dr7r10 | 1.93 | Y1R1/Y5R2 | 1.52 |
| Dr2r5/Dr8r10 | 0.52 | — | — |

### 5th Embodiment

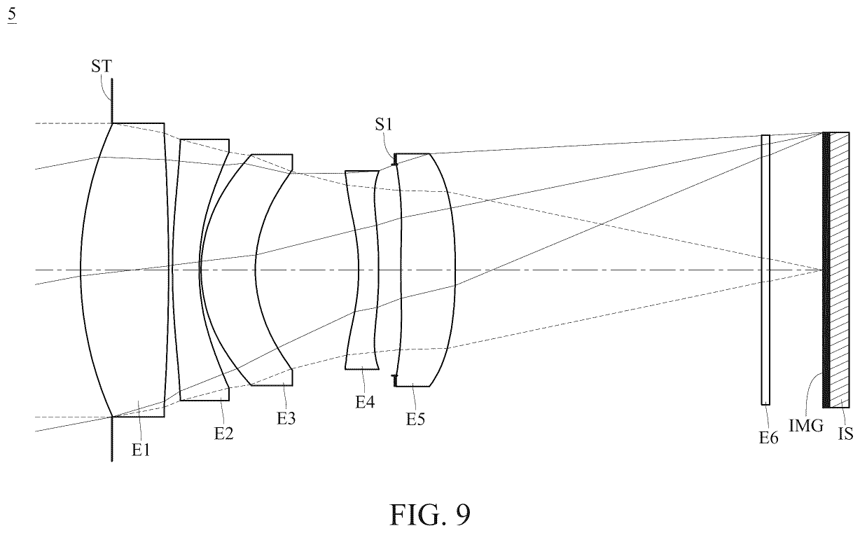

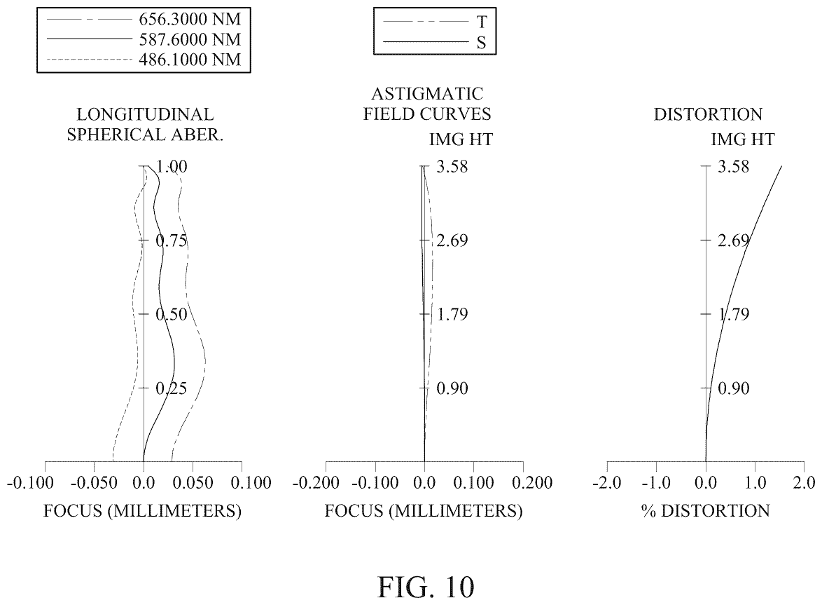

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The image-side surface of the fourth lens element E4 has one critical point in an off-axis region thereof.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric. The object-side surface of the fifth lens element E5 has one inflection point. The object-side surface of the fifth lens element E5 has one critical point in an off-axis region thereof.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 5th embodiment are shown in Table 5A and the aspheric surface data are shown in Table 5B below.

TABLE 5A
5th Embodiment
f = 18.64 mm, Fno = 2.43, HFOV = 10.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.819 | | | | |
| 2 | Lens 1 | 9.1855 | (SPH) | 2.300 | Glass | 1.729 | 54.7 | 10.95 |
| 3 | | −54.6233 | (SPH) | 0.100 | | | | |
| 4 | Lens 2 | 18.7298 | (ASP) | 0.698 | Plastic | 1.587 | 28.3 | −14.50 |
| 5 | | 5.7738 | (ASP) | 0.050 | | | | |
| 6 | Lens 3 | 3.6928 | (ASP) | 1.416 | Plastic | 1.544 | 56.0 | 63.06 |
| 7 | | 3.5791 | (ASP) | 2.700 | | | | |
| 8 | Lens 4 | −5.5846 | (ASP) | 0.521 | Plastic | 1.616 | 25.3 | −15.39 |
| 9 | | −14.0886 | (ASP) | 0.416 | | | | |
| 10 | Stop | Plano | | 0.162 | | | | |
| 11 | Lens 5 | 19.7700 | (ASP) | 1.425 | Plastic | 1.584 | 28.2 | 14.13 |
| 12 | | −13.8027 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 1.389 | | | | |
| 15 | Image | Plano | — | | | | |

Note:
Reference wavelength is 587.6 nm (d-line).
An effective radius of the stop S1 (Surface 10) is 2.755 mm.

TABLE 5B
Aspheric Coefficients

| Surface # | 4 | 5 | 6 | 7 |
|---|---|---|---|---|
| k = | 0.00000E+00 | 1.52093E+00 | 0.00000E+00 | 0.00000E+00 |
| A4 = | 2.488143E−04 | −2.793794E−03 | −4.487518E−03 | −3.389505E−03 |
| A6 = | −1.765208E−04 | 9.196669E−04 | 1.250991E−03 | −1.125806E−04 |
| A8 = | 7.204058E−06 | −2.415515E−04 | −2.228543E−04 | 1.444607E−04 |
| A10 = | 1.456757E−07 | 2.115460E−05 | 1.562177E−05 | −2.682444E−05 |
| A12 = | −9.647043E−09 | −6.814140E−07 | −4.681810E−07 | 1.048119E−06 |
| Surface # | 8 | 9 | 11 | 12 |
| k = | 0.00000E+00 | 0.00000E+00 | 0.00000E+00 | 0.00000E+00 |
| A4 = | −7.892083E−04 | −8.255033E−03 | −1.119396E−02 | −3.019579E−03 |
| A6 = | 1.938902E−03 | 2.955093E−03 | 8.796486E−04 | −2.583191E−04 |
| A8 = | 1.191360E−04 | 1.063404E−04 | 1.732235E−04 | 9.204138E−05 |
| A10 = | −8.311222E−05 | −7.878061E−05 | −6.161527E−05 | −1.817262E−05 |
| A12 = | 9.654001E−06 | 8.493619E−06 | 6.935785E−06 | 1.632170E−06 |
| A14 = | −4.373089E−07 | −3.165271E−07 | −2.738416E−07 | −5.989827E−08 |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment, with corresponding values for the 5th embodiment; therefore, an explanation in this regard will not be provided again.

Moreover, these parameters can be calculated from Table 5A and Table 5B as the following values and satisfy the following conditions:

TABLE 5C
Values of Optical and Physical Parameters/Definitions

| | | | |
|---|---|---|---|
| f [mm] | 18.64 | \|R3/R2\| | 0.34 |
| Fno | 2.43 | \|R4/R10\| | 0.42 |
| HFOV [deg.] | 10.7 | R6/R7 | −0.64 |
| FOV [deg.] | 21.4 | R9/R10 | −1.43 |
| TL/ImgH | 5.41 | (R5 − R6)/(R5 + R6) | 0.02 |
| BL/ImgH | 2.68 | CT1/CT2 | 3.30 |
| TD/BL | 1.02 | (T12 + T23 + T45)/T34 | 0.27 |
| BL/T34 | 3.56 | T23/T45 | 0.09 |
| BL/ΣAT | 2.80 | T34/Dr1r6 | 0.59 |
| f/f3 | 0.30 | V2 | 28.3 |
| \|f1/f2\| | 0.76 | V3 | 56.0 |
| f1/f3 | 0.17 | V4 | 25.3 |
| (f1 + f2)/(f4 + f5) | 2.83 | Y3R2/Y4R1 | 1.10 |
| Dr1r6/Dr7r10 | 1.81 | Y1R1/Y5R2 | 1.26 |
| Dr2r5/Dr8r10 | 0.42 | — | — |

### 6th Embodiment

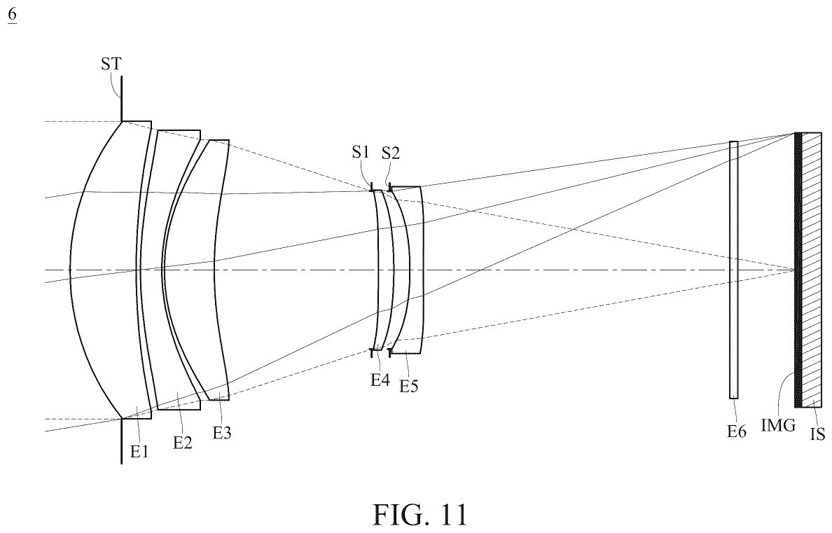

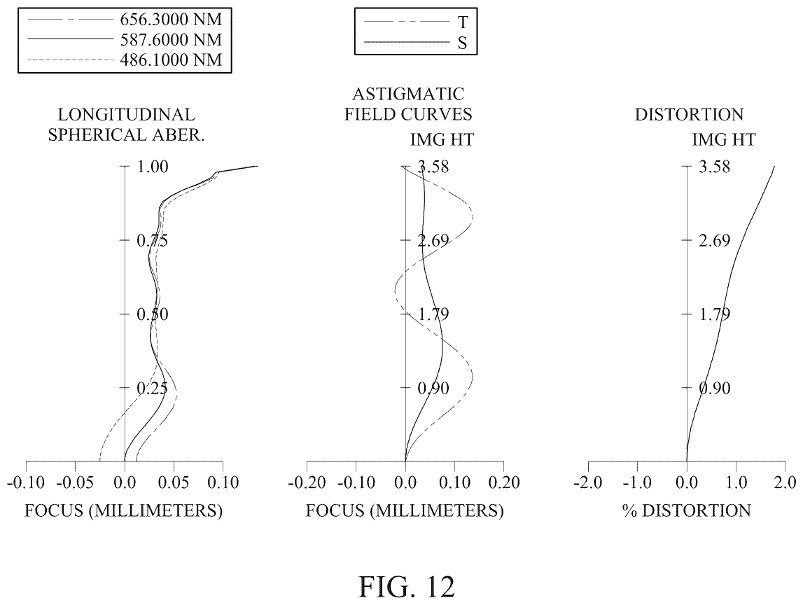

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a stop S1, a fourth lens element E4, a stop S2, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has three inflection points. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point. The image-side surface of the fifth lens element E5 has one critical point in an off-axis region thereof.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 6th embodiment are shown in Table 6A and the aspheric surface data are shown in Table 6B below.

TABLE 6A
6th Embodiment
f = 21.42 mm, Fno = 2.76, HFOV = 9.3 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −1.348 | | | | |
| 2 | Lens 1 | 6.1924 | (SPH) | 1.727 | Glass | 1.497 | 81.6 | 18.35 |
| 3 | | 17.5063 | (SPH) | 0.112 | | | | |
| 4 | Lens 2 | 9.4598 | (ASP) | 0.558 | Plastic | 1.616 | 24.9 | −17.60 |
| 5 | | 4.9361 | (ASP) | 0.068 | | | | |
| 6 | Lens 3 | 4.7654 | (ASP) | 1.301 | Plastic | 1.544 | 56.0 | 15.64 |
| 7 | | 9.7919 | (ASP) | 4.110 | | | | |
| 8 | Stop | Plano | | 0.176 | | | | |
| 9 | Lens 4 | −79.3777 | (ASP) | 0.404 | Plastic | 1.697 | 16.3 | 14.98 |
| 10 | | −9.2477 | (ASP) | −0.105 | | | | |
| 11 | Stop | Plano | | 0.525 | | | | |
| 12 | Lens 5 | −6.5631 | (ASP) | 0.350 | Plastic | 1.587 | 28.3 | −9.63 |
| 13 | | 41.6087 | (ASP) | 8.000 | | | | |

| | | | | | | | |
|---|---|---|---|---|---|---|---|
| 14 | Filter | Plano | 0.210 | Glass | 1.517 | 64.2 | — |
| 15 | | Plano | 1.497 | | | | |
| 16 | Image | Plano | — | | | | |

Note:
Reference wavelength is 587.6 nm (d-line).
An effective radius of the stop S1 (Surface 8) is 2.068 mm.
An effective radius of the stop S2 (Surface 11) is 2.063 mm.

TABLE 6B
Aspheric Coefficients

| Surface # | 4 | 5 | 6 | 7 |
|---|---|---|---|---|
| k = | 0.00000E+00 | 3.68709E−01 | 0.00000E+00 | 0.00000E+00 |
| A4 = | −5.539278E−03 | −1.503195E−02 | −9.076028E−03 | 2.542788E−05 |
| A6 = | 3.014322E−03 | 1.463233E−02 | 1.183979E−02 | −7.893171E−04 |
| A8 = | −1.310876E−03 | −8.036547E−03 | −6.877667E−03 | 4.062217E−04 |
| A10 = | 3.406944E−04 | 2.458684E−03 | 2.166798E−03 | −1.315868E−04 |
| A12 = | −5.419295E−05 | −4.539107E−04 | −4.106300E−04 | 2.439161E−05 |
| A14 = | 5.337419E−06 | 5.179737E−05 | 4.810577E−05 | −2.631797E−06 |
| A16 = | −3.178238E−07 | −3.578077E−06 | −3.412400E−06 | 1.606402E−07 |
| A18 = | 1.048782E−08 | 1.371944E−07 | 1.343462E−07 | −4.961293E−09 |
| A20 = | −1.472730E−10 | −2.241612E−09 | −2.252811E−09 | 5.542208E−11 |
| Surface # | 9 | 10 | 12 | 13 |
| k = | 1.28284E+01 | −8.67092E−02 | −1.16871E−01 | −5.76147E+01 |
| A4 = | 3.699947E−03 | 1.406043E−02 | 2.250587E−02 | 1.415854E−02 |
| A6 = | −8.668163E−03 | −2.469289E−02 | −6.549719E−02 | −5.113768E−02 |
| A8 = | 3.099062E−03 | 1.698372E−02 | 6.641627E−02 | 5.694669E−02 |
| A10 = | 7.749985E−04 | −6.221088E−03 | −3.851244E−02 | −3.653161E−02 |
| A12 = | −1.234559E−03 | 8.766623E−04 | 1.343770E−02 | 1.452084E−02 |
| A14 = | 5.116346E−04 | 1.317251E−04 | −2.819939E−03 | −3.628431E−03 |
| A16 = | −1.070783E−04 | −6.812627E−05 | 3.378801E−04 | 5.551287E−04 |
| A18 = | 1.176476E−05 | 9.752976E−06 | −1.987317E−05 | −4.756319E−05 |
| A20 = | −5.472943E−07 | −5.107776E−07 | 3.495529E−07 | 1.749735E−06 |

In the 6th embodiment, the equation of the aspheric surface profiles of the aforementioned lens elements is the same as the equation of the 1st embodiment. Also, the definitions of these parameters shown in Table 60 below are the same as those stated in the 1st embodiment, with corresponding values for the 6th embodiment; therefore, an explanation in this regard will not be provided again.

Moreover, these parameters can be calculated from Table 6A and Table 6B as the following values and satisfy the following conditions:

TABLE 6C
Values of Optical and Physical Parameters/Definitions

| | | | |
|---|---|---|---|
| f [mm] | 21.42 | \|R3/R2\| | 0.54 |
| Fno | 2.76 | \|R4/R10\| | 0.12 |
| HFOV [deg.] | 9.3 | R6/R7 | −0.12 |
| FOV [deg.] | 18.6 | R9/R10 | −0.16 |
| TL/ImgH | 5.28 | (R5 − R6)/(R5 + R6) | −0.35 |
| BL/ImgH | 2.71 | CT1/CT2 | 3.09 |
| TD/BL | 0.95 | (T12 + T23 + T45)/T34 | 0.14 |
| BL/T34 | 2.26 | T23/T45 | 0.16 |
| BL/ΣAT | 1.99 | T34/Dr1r6 | 1.14 |
| f/f3 | 1.37 | V2 | 24.9 |
| \|f1/f2\| | 1.04 | V3 | 56.0 |
| f1/f3 | 1.17 | V4 | 16.3 |
| (f1 + f2)/(f4 + f5) | 0.14 | Y3R2/Y4R1 | 1.58 |
| Dr1r6/Dr7r10 | 3.21 | Y1R1/Y5R2 | 1.78 |
| Dr2r5/Dr8r10 | 0.96 | — | — |

### 7th Embodiment

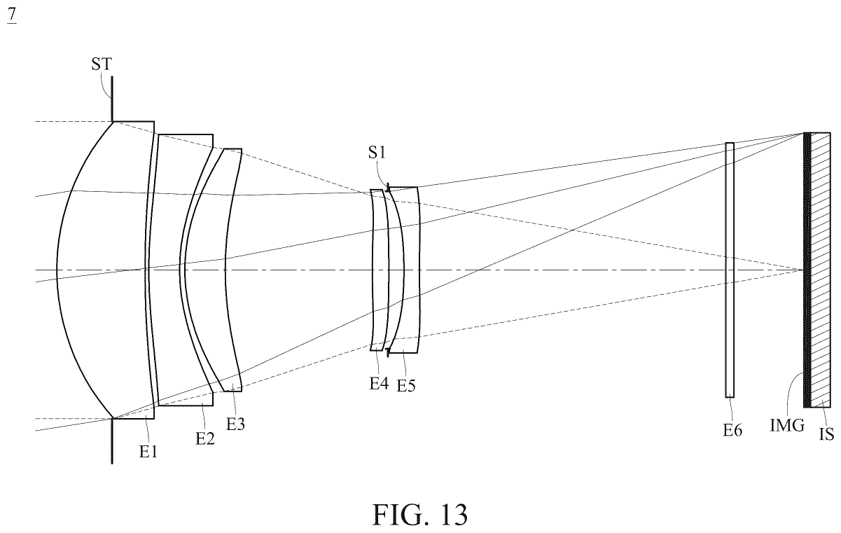

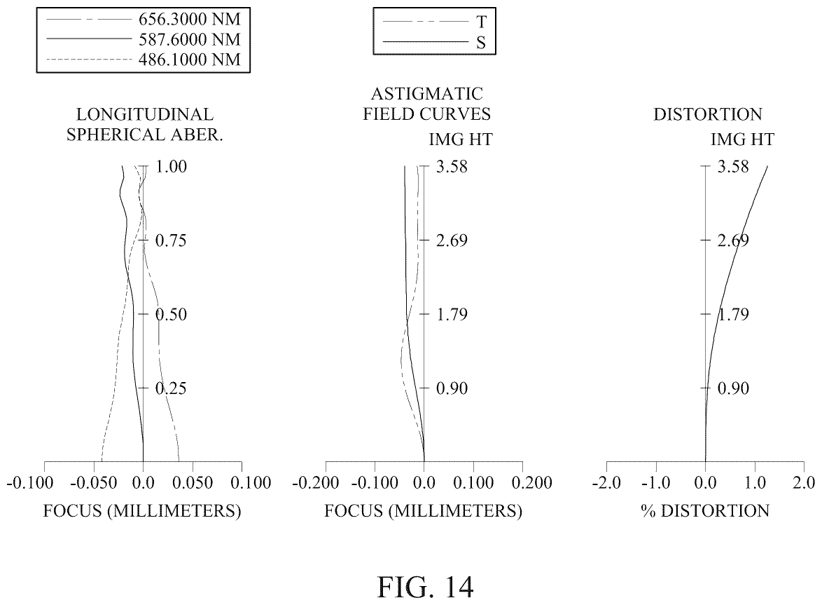

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The object-side surface of the fourth lens element E4 has one critical point in an off-axis region thereof.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point. The image-side surface of the fifth lens element E5 has one critical point in an off-axis region thereof.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 7th embodiment are shown in Table 7A and the aspheric surface data are shown in Table 7B below.

TABLE 7A
7th Embodiment
f = 22.55 mm, Fno = 2.90, HFOV = 8.9 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −1.440 | | | | |
| 2 | Lens 1 | 5.8008 | (SPH) | 2.303 | Glass | 1.510 | 63.4 | 13.93 |
| 3 | | 27.3454 | (SPH) | 0.100 | | | | |
| 4 | Lens 2 | 12.8400 | (ASP) | 0.805 | Plastic | 1.616 | 25.3 | −13.50 |
| 5 | | 4.9247 | (ASP) | 0.137 | | | | |
| 6 | Lens 3 | 4.7550 | (ASP) | 1.053 | Plastic | 1.544 | 56.0 | 17.94 |
| 7 | | 8.5495 | (ASP) | 3.842 | | | | |
| 8 | Lens 4 | 23.8095 | (ASP) | 0.430 | Plastic | 1.669 | 19.5 | 21.36 |
| 9 | | −35.4963 | (ASP) | −0.026 | | | | |
| 10 | Stop | Plano | | 0.422 | | | | |
| 11 | Lens 5 | −9.1613 | (ASP) | 0.403 | Plastic | 1.544 | 56.0 | −12.20 |
| 12 | | 24.4704 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 1.833 | | | | |
| 15 | Image | Plano | — | | | | |

Note:
Reference wavelength is 587.6 nm (d-line).
An effective radius of the stop S1 (Surface 10) is 2.057 mm.

TABLE 7B
Aspheric Coefficients

| Surface # | 4 | 5 | 6 | 7 |
|---|---|---|---|---|
| k = | 0.00000E+00 | 3.05945E−01 | 0.00000E+00 | 0.00000E+00 |
| A4 = | −2.189993E−03 | −9.341248E−04 | 2.101031E−03 | −4.291239E−04 |
| A6 = | 4.652239E−05 | −2.294025E−03 | −2.950344E−03 | −7.808772E−04 |
| A8 = | −6.755409E−07 | 9.144432E−04 | 1.162164E−03 | 3.723978E−04 |
| A10 = | 2.890144E−06 | −1.902910E−04 | −2.454313E−04 | −9.869159E−05 |
| A12 = | −9.737249E−07 | 2.059508E−05 | 2.844693E−05 | 1.599700E−05 |
| A14 = | 1.471944E−07 | −8.656325E−07 | −1.654025E−06 | −1.671787E−06 |
| A16 = | −1.175161E−08 | −3.317105E−08 | 2.487221E−08 | 1.115459E−07 |
| A18 = | 4.827713E−10 | 4.502338E−09 | 1.583465E−09 | −4.521208E−09 |
| A20 = | −8.062390E−12 | −1.209289E−10 | −4.985148E−11 | 8.854992E−11 |
| Surface # | 8 | 9 | 11 | 12 |
| k = | 3.27818E+01 | 5.90978E+01 | −3.48097E+00 | 6.59349E+01 |
| A4 = | 6.022956E−04 | 8.827125E−03 | 4.372333E−03 | −4.927835E−03 |
| A6 = | −7.827125E−03 | −1.593940E−02 | −2.204263E−02 | −8.214536E−03 |
| A8 = | 6.166432E−03 | 1.226596E−02 | 1.861292E−02 | 6.843420E−03 |
| A10 = | −3.844738E−03 | −7.082281E−03 | −1.010317E−02 | −3.046239E−03 |
| A12 = | 1.679393E−03 | 2.946548E−03 | 3.822670E−03 | 8.322642E−04 |
| A14 = | −4.915402E−04 | −8.427320E−04 | −1.008401E−03 | −1.423807E−04 |
| A16 = | 9.063023E−05 | 1.542834E−04 | 1.756545E−04 | 1.476125E−05 |
| A18 = | −9.462223E−06 | −1.613489E−05 | −1.802058E−05 | −8.483242E−07 |
| A20 = | 4.254153E−07 | 7.295036E−07 | 8.182891E−07 | 2.121271E−08 |

In the 7th embodiment, the equation of the aspheric surface profiles of the aforementioned lens elements is the same as the equation of the 1st embodiment. Also, the definitions of these parameters shown in Table 70 below are the same as those stated in the 1st embodiment, with corresponding values for the 7th embodiment; therefore, an explanation in this regard will not be provided again.

Moreover, these parameters can be calculated from Table 7A and Table 71B as the following values and satisfy the following conditions:

TABLE 7C
Values of Optical and Physical Parameters/Definitions

| | | | |
|---|---|---|---|
| f [mm] | 22.55 | \|R3/R2\| | 0.47 |
| Fno | 2.90 | \|R4/R10\| | 0.20 |
| HFOV [deg.] | 8.9 | R6/R7 | 0.36 |
| FOV [deg.] | 17.8 | R9/R10 | −0.37 |
| TL/ImgH | 5.44 | (R5 − R6)/(R5 + R6) | −0.29 |
| BL/ImgH | 2.80 | CT1/CT2 | 2.86 |
| TD/BL | 0.94 | (T12 + T23 + T45)/T34 | 0.16 |
| BL/T34 | 2.61 | T23/T45 | 0.35 |
| BL/ΣAT | 2.24 | T34/Dr1r6 | 0.87 |
| f/f3 | 1.26 | V2 | 25.3 |
| \|f1/f2\| | 1.03 | V3 | 56.0 |
| f1/f3 | 0.78 | V4 | 19.5 |
| (f1 + f2)/(f4 + f5) | 0.05 | Y3R2/Y4R1 | 1.47 |
| Dr1r6/Dr7r10 | 3.58 | Y1R1/Y5R2 | 1.79 |
| Dr2r5/Dr8r10 | 1.30 | — | — |

### 8th Embodiment

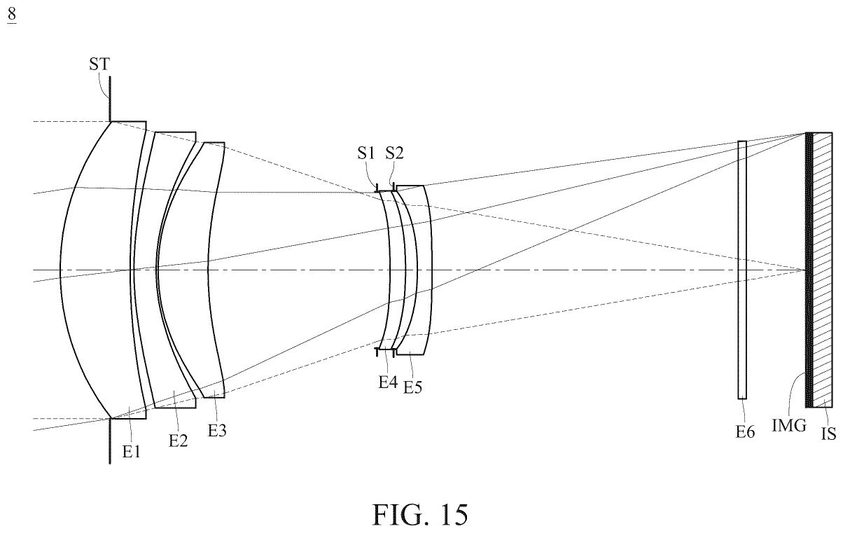

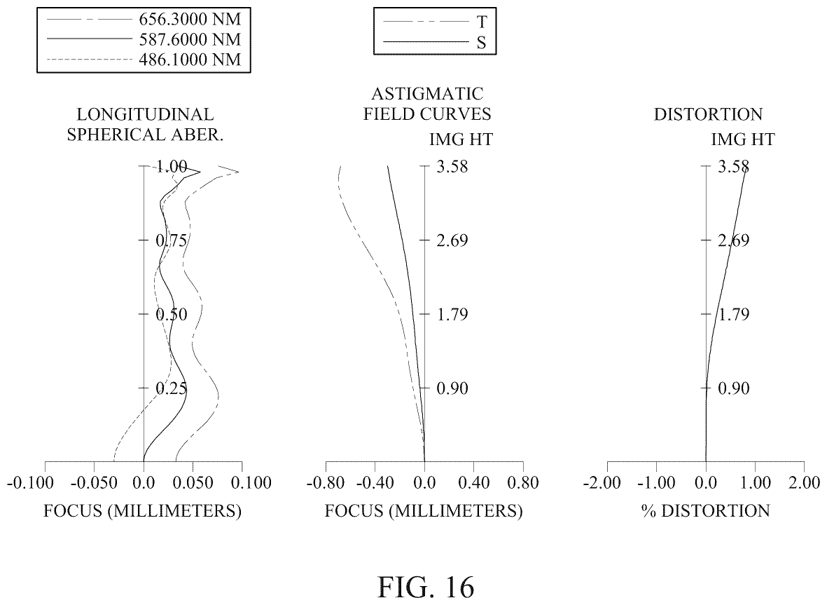

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a stop S1, a fourth lens element E4, a stop S2, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 8th embodiment are shown in Table 8A and the aspheric surface data are shown in Table 8B below.

TABLE 8A
8th Embodiment
f = 23.09 mm, Fno = 2.97, HFOV = 8.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −1.299 | | | | |
| 2 | Lens 1 | 6.2624 | (SPH) | 1.827 | Glass | 1.497 | 81.6 | 19.26 |
| 3 | | 16.3504 | (SPH) | 0.100 | | | | |
| 4 | Lens 2 | 8.3125 | (ASP) | 0.580 | Plastic | 1.616 | 25.3 | −19.32 |
| 5 | | 4.7626 | (ASP) | 0.050 | | | | |
| 6 | Lens 3 | 4.5221 | (ASP) | 1.306 | Plastic | 1.544 | 56.0 | 15.65 |
| 7 | | 8.6657 | (ASP) | 4.412 | | | | |
| 8 | Stop | Plano | | 0.341 | | | | |
| 9 | Lens 4 | −12.7183 | (ASP) | 0.406 | Plastic | 1.669 | 19.5 | 26.41 |
| 10 | | −7.4902 | (ASP) | −0.314 | | | | |
| 11 | Stop | Plano | | 0.622 | | | | |
| 12 | Lens 5 | −6.0360 | (ASP) | 0.380 | Plastic | 1.544 | 56.0 | −12.04 |
| 13 | | −78.2602 | (ASP) | 8.000 | | | | |

| | | | | | | | |
|---|---|---|---|---|---|---|---|
| 14 | Filter | Plano | 0.210 | Glass | 1.517 | 64.2 | — |
| 15 | | Plano | 1.558 | | | | |
| 16 | Image | Plano | — | | | | |

Note:
Reference wavelength is 587.6 nm (d-line).
An effective radius of the stop S1 (Surface 8) is 2.040 mm.
An effective radius of the stop S2 (Surface 11) is 2.065 mm.

TABLE 8B
Aspheric Coefficients

| Surface # | 4 | 5 | 6 | 7 |
|---|---|---|---|---|
| k = | 0.00000E+00 | 3.31009E−01 | 0.00000E+00 | 0.00000E+00 |
| A4 = | −9.632305E−04 | −9.338518E−03 | −1.372452E−02 | −7.004558E−03 |
| A6 = | −1.080045E−03 | 9.641735E−03 | 1.627411E−02 | 6.739798E−03 |
| A8 = | 2.933276E−04 | −6.373064E−03 | −9.125399E−03 | −3.455124E−03 |
| A10 = | −1.408517E−05 | 2.207027E−03 | 2.822565E−03 | 1.018533E−03 |
| A12 = | −6.212296E−06 | −4.424796E−04 | −5.225651E−04 | −1.858659E−04 |
| A14 = | 1.282465E−06 | 5.328680E−05 | 5.920988E−05 | 2.123278E−05 |
| A16 = | −1.083761E−07 | −3.805206E−06 | −4.018788E−06 | −1.476242E−06 |
| A18 = | 4.426529E−09 | 1.485181E−07 | 1.498194E−07 | 5.699949E−08 |
| A20 = | −7.182144E−11 | −2.441205E−09 | −2.355738E−09 | −9.352486E−10 |
| Surface # | 9 | 10 | 12 | 13 |
| k = | 2.13098E+00 | 2.99010E−01 | −2.32162E−01 | 6.30107E+01 |
| A4 = | 1.234699E−02 | 2.658326E−02 | 1.420706E−02 | −4.824684E−03 |
| A6 = | −2.955854E−02 | −5.320307E−02 | −6.247912E−02 | −2.078754E−02 |
| A8 = | 2.778043E−02 | 4.763599E−02 | 7.094411E−02 | 2.804809E−02 |
| A10 = | −1.958490E−02 | −2.815795E−02 | −4.519579E−02 | −1.863162E−02 |
| A12 = | 1.014382E−02 | 1.206548E−02 | 1.826910E−02 | 7.238200E−03 |
| A14 = | −3.534807E−03 | −3.699675E−03 | −4.914876E−03 | −1.729126E−03 |
| A16 = | 7.584584E−04 | 7.415193E−04 | 8.621069E−04 | 2.513251E−04 |
| A18 = | −8.941326E−05 | −8.450423E−05 | −8.902173E−05 | −2.047764E−05 |
| A20 = | 4.413966E−06 | 4.095136E−06 | 4.068219E−06 | 7.194131E−07 |

In the 8th embodiment, the equation of the aspheric surface profiles of the aforementioned lens elements is the same as the equation of the 1st embodiment. Also, the definitions of these parameters shown in Table 80 below are the same as those stated in the 1st embodiment, with corresponding values for the 8th embodiment; therefore, an explanation in this regard will not be provided again.

Moreover, these parameters can be calculated from Table 8A and Table 8B as the following values and satisfy the following conditions:

TABLE 8C
Values of Optical and Physical Parameters/Definitions

| | | | |
|---|---|---|---|
| f [mm] | 23.09 | \|R3/R2\| | 0.51 |
| Fno | 2.97 | \|R4/R10\| | 0.06 |
| HFOV [deg.] | 8.7 | R6/R7 | −0.68 |
| FOV [deg.] | 17.4 | R9/R10 | 0.08 |
| TL/ImgH | 5.43 | (R5 − R6)/(R5 + R6) | −0.31 |
| BL/ImgH | 2.73 | CT1/CT2 | 3.15 |
| TD/BL | 0.99 | (T12 + T23 + T45)/T34 | 0.10 |
| BL/T34 | 2.06 | T23/T45 | 0.16 |
| BL/ΣAT | 1.87 | T34/Dr1r6 | 1.23 |
| f/f3 | 1.48 | V2 | 25.3 |
| \|f1/f2\| | 1.00 | V3 | 56.0 |
| f1/f3 | 1.23 | V4 | 19.5 |
| (f1 + f2)/(f4 + f5) | −0.004 | Y3R2/Y4R1 | 1.61 |
| Dr1r6/Dr7r10 | 3.53 | Y1R1/Y5R2 | 1.76 |
| Dr2r5/Dr8r10 | 1.06 | — | — |

### 9th Embodiment

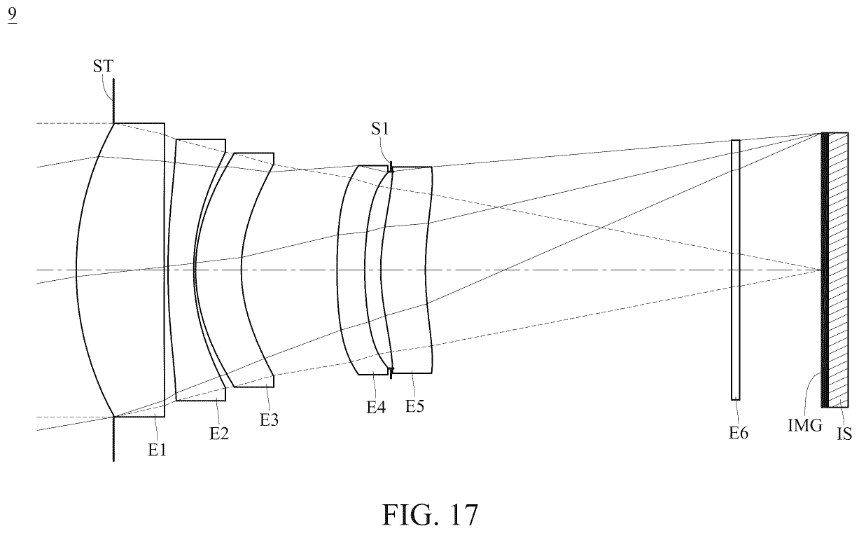

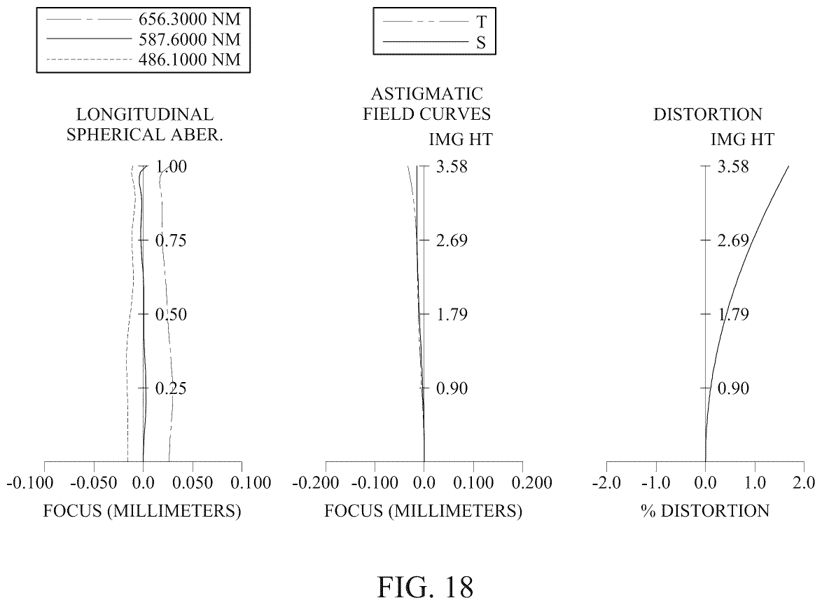

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric.

The fifth lens element E5 with positive refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has one inflection point. The image-side surface of the fifth lens element E5 has one critical point in an off-axis region thereof.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 9th embodiment are shown in Table 9A and the aspheric surface data are shown in Table 9B below.

TABLE 9A
9th Embodiment
f = 20.00 mm, Fno = 2.61, HFOV = 10.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −0.976 | | | | |
| 2 | Lens 1 | 7.8721 | (SPH) | 2.300 | Glass | 1.729 | 54.7 | 10.90 |
| 3 | | 697.6204 | (SPH) | 0.100 | | | | |
| 4 | Lens 2 | 18.2029 | (ASP) | 0.671 | Plastic | 1.616 | 25.3 | −13.81 |
| 5 | | 5.7127 | (ASP) | 0.050 | | | | |
| 6 | Lens 3 | 4.3382 | (ASP) | 1.193 | Plastic | 1.544 | 56.0 | 303.11 |
| 7 | | 4.0237 | (ASP) | 2.500 | | | | |
| 8 | Lens 4 | 14.7529 | (ASP) | 0.723 | Plastic | 1.697 | 16.3 | −24.04 |
| 9 | | 7.6884 | (ASP) | 0.688 | | | | |
| 10 | Stop | Plano | | −0.268 | | | | |
| 11 | Lens 5 | 5.1180 | (ASP) | 1.167 | Plastic | 1.680 | 18.2 | 16.98 |
| 12 | | 8.3450 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 2.145 | | | | |
| 15 | Image | Plano | — | | | | |

Note:
Reference wavelength is 587.6 nm (d-line).
An effective radius of the stop S1 (Surface 10) is 2.570 mm.

TABLE 9B
Aspheric Coefficients

| Surface # | 4 | 5 | 6 | 7 |
|---|---|---|---|---|
| k = | 0.00000E+00 | 1.38179E+00 | 0.00000E+00 | 0.00000E+00 |
| A4 = | −6.449227E−05 | −1.715148E−03 | −3.635985E−03 | −3.922536E−03 |
| A6 = | −1.104664E−04 | 4.937457E−04 | 8.051748E−04 | 6.855966E−05 |
| A8 = | 3.705750E−06 | −1.587855E−04 | −1.930800E−04 | −3.775043E−05 |
| A10 = | 1.613026E−07 | 1.650562E−05 | 1.971014E−05 | 4.844491E−06 |
| A12 = | −1.028191E−08 | −6.713465E−07 | −7.817514E−07 | −2.968049E−07 |
| Surface # | 8 | 9 | 11 | 12 |
| k = | 0.00000E+00 | 0.00000E+00 | 0.00000E+00 | 0.00000E+00 |
| A4 = | 2.002954E−03 | −7.726813E−03 | −1.380226E−02 | −4.675986E−03 |
| A6 = | 9.138170E−04 | 3.083041E−03 | 1.404565E−03 | −2.240801E−04 |
| A8 = | −1.009985E−04 | −3.377517E−04 | −7.826231E−05 | 8.940103E−05 |
| A10 = | 8.124305E−06 | 2.559926E−05 | −1.474762E−05 | −2.074330E−05 |
| A12 = | −3.134134E−07 | −2.316910E−07 | 2.772346E−06 | 2.137550E−06 |
| A14 = | −4.209700E−09 | −5.748014E−08 | −1.515349E−07 | −9.422219E−08 |

In the 9th embodiment, the equation of the aspheric surface profiles of the aforementioned lens elements is the same as the equation of the 1st embodiment. Also, the definitions of these parameters shown in Table 90 below are the same as those stated in the 1st embodiment, with corresponding values for the 9th embodiment; therefore, an explanation in this regard will not be provided again.

Moreover, these parameters can be calculated from Table 9A and Table 9B as the following values and satisfy the following conditions:

TABLE 9C
Values of Optical and Physical Parameters/Definitions

| | | | |
|---|---|---|---|
| f [mm] | 20.00 | \|R3/R2\| | 0.03 |
| Fno | 2.61 | \|R4/R10\| | 0.68 |
| HFOV [deg.] | 10.0 | R6/R7 | 0.27 |
| FOV [deg.] | 20.0 | R9/R10 | 0.61 |
| TL/ImgH | 5.43 | (R5 − R6)/(R5 + R6) | 0.04 |
| BL/ImgH | 2.89 | CT1/CT2 | 3.43 |
| TD/BL | 0.88 | (T12 + T23 + T45)/T34 | 0.23 |
| BL/T34 | 4.14 | T23/T45 | 0.12 |
| BL/ΣAT | 3.37 | T34/Dr1r6 | 0.58 |
| f/f3 | 0.07 | V2 | 25.3 |
| \|f1/f2\| | 0.79 | V3 | 56.0 |
| f1/f3 | 0.04 | V4 | 16.3 |
| (f1 + f2)/(f4 + f5) | 0.41 | Y3R2/Y4R1 | 1.06 |
| Dr1r6/Dr7r10 | 1.87 | Y1R1/Y5R2 | 1.42 |
| Dr2r5/Dr8r10 | 0.52 | — | — |

### 10th Embodiment

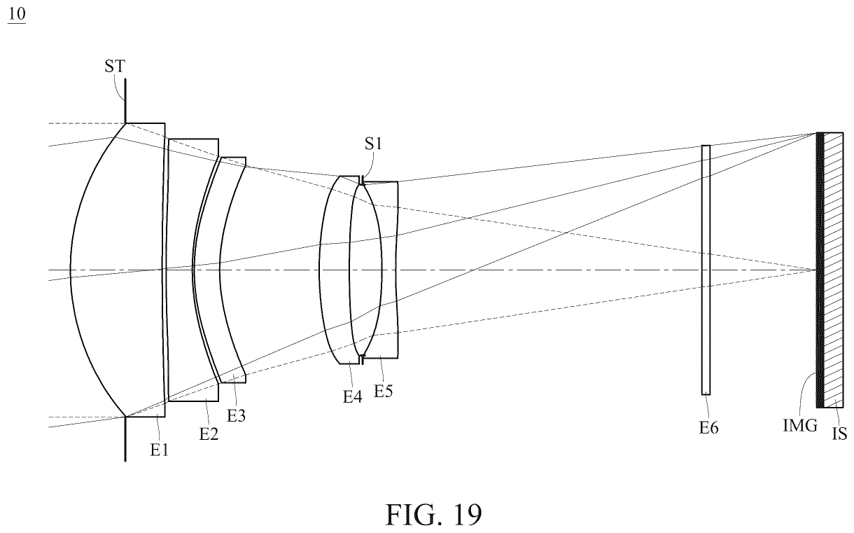

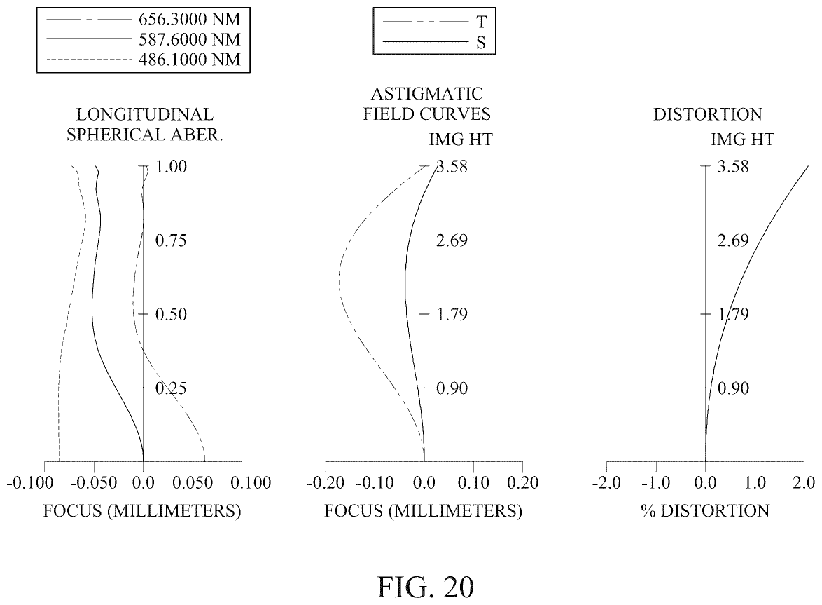

FIG. 19 is a schematic view of an image capturing unit according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit 10 includes the imaging lens system (its reference numeral is omitted) of the present disclosure and an image sensor IS. The imaging lens system includes, in order from an object side to an image side along an optical path, an aperture stop ST, a first lens element E1, a second lens element E2, a third lens element E3, a fourth lens element E4, a stop S1, a fifth lens element E5, a filter E6 and an image surface IMG. The imaging lens system includes five lens elements (E1, E2, E3, E4 and E5) with no additional lens element disposed between each of the adjacent five lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being concave in a paraxial region thereof. The fourth lens element E4 is made of plastic material and has the object-side surface and the image-side surface being both aspheric.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The image-side surface of the fifth lens element E5 has one inflection point. The image-side surface of the fifth lens element E5 has one critical point in an off-axis region thereof.

The filter E6 is made of glass material and located between the fifth lens element E5 and the image surface IMG, and will not affect the focal length of the imaging lens system. The image sensor IS is disposed on or near the image surface IMG of the imaging lens system.

The detailed optical data of the 10th embodiment are shown in Table 10A and the aspheric surface data are shown in Table 10B below.

TABLE 10A
10th Embodiment
f = 25.93 mm, Fno = 3.38, HFOV = 7.7 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Ape. Stop | Plano | | −1.435 | | | | |
| 2 | Lens 1 | 5.7593 | (ASP) | 2.399 | Glass | 1.729 | 54.7 | 8.30 |
| 3 | | 98.8452 | (ASP) | 0.101 | | | | |
| 4 | Lens 2 | 38.7868 | (ASP) | 0.686 | Plastic | 1.642 | 22.5 | −11.37 |
| 5 | | 6.0997 | (ASP) | 0.050 | | | | |
| 6 | Lens 3 | 5.0813 | (ASP) | 0.664 | Plastic | 1.544 | 56.0 | −215.75 |
| 7 | | 4.6462 | (ASP) | 2.600 | | | | |
| 8 | Lens 4 | 8.3179 | (ASP) | 0.788 | Plastic | 1.697 | 16.3 | 17.91 |
| 9 | | 23.9576 | (ASP) | 0.346 | | | | |
| 10 | Stop | Plano | | 0.505 | | | | |
| 11 | Lens 5 | −8.7046 | (ASP) | 0.359 | Plastic | 1.566 | 37.4 | −9.15 |
| 12 | | 12.9796 | (ASP) | 8.000 | | | | |

| | | | | | | | |
|---|---|---|---|---|---|---|---|
| 13 | Filter | Plano | 0.210 | Glass | 1.517 | 64.2 | — |
| 14 | | Plano | 2.794 | | | | |
| 15 | Image | Plano | — | | | | |

Note:
Reference wavelength is 587.6 nm (d-line).
An effective radius of the stop S1 (Surface 10) is 2.231 mm.

TABLE 10B
Aspheric Coefficients

| Surface # | 2 | 3 | 4 | 5 |
|---|---|---|---|---|
| k = | −1.67385E−02 | 1.05678E+01 | 0.00000E+00 | 1.68657E+00 |
| A4 = | −6.877084E−05 | 4.736922E−04 | 4.729980E−04 | 1.281015E−03 |
| A6 = | 2.526584E−06 | −9.495981E−05 | −3.219546E−04 | −1.161514E−03 |
| A8 = | 8.021137E−08 | 4.824849E−06 | 2.929357E−05 | 1.414991E−04 |
| A10 = | — | — | −1.037861E−06 | −9.983643E−06 |
| A12 = | — | — | 1.785931E−08 | 3.249550E−07 |
| Surface # | 6 | 7 | 8 | 9 |
| k = | 0.00000E+00 | 0.00000E+00 | 0.00000E+00 | 0.00000E+00 |
| A4 = | −1.688939E−03 | −6.353143E−03 | −6.832358E−04 | 2.372541E−03 |
| A6 = | −5.122222E−04 | 7.806234E−04 | 9.154061E−04 | 4.044871E−04 |
| A8 = | 8.316423E−05 | −1.006429E−04 | −3.157023E−04 | −6.776281E−04 |
| A10 = | −7.600836E−06 | 7.936614E−06 | 1.083771E−04 | 3.361514E−04 |
| A12 = | 3.216571E−07 | −3.131120E−07 | −1.452057E−05 | −5.986494E−05 |
| A14 = | — | — | 8.563438E−07 | 4.406473E−06 |

| Surface # | 11 | 12 |
|---|---|---|
| k = | 0.00000E+00 | 0.00000E+00 |
| A4 = | 4.627482E−03 | 1.537543E−03 |
| A6 = | −1.176556E−02 | −8.374228E−03 |
| A8 = | 4.576617E−03 | 3.646654E−03 |
| A10 = | −9.235080E−04 | −7.886128E−04 |
| A12 = | 9.544293E−05 | 8.668062E−05 |
| A14 = | −3.956726E−06 | −3.824944E−06 |

In the 10th embodiment, the equation of the aspheric surface profiles of the aforementioned lens elements is the same as the equation of the 1st embodiment. Also, the definitions of these parameters shown in Table 10C below are the same as those stated in the 1st embodiment, with corresponding values for the 10th embodiment; therefore, an explanation in this regard will not be provided again.

Moreover, these parameters can be calculated from Table 10A and Table 10B as the following values and satisfy the following conditions:

TABLE 10C
Values of Optical and Physical Parameters/Definitions

| | | | |
|---|---|---|---|
| f [mm] | 25.93 | \|R3/R2\| | 0.39 |
| Fno | 3.38 | \|R4/R10\| | 0.47 |
| HFOV [deg.] | 7.7 | R6/R7 | 0.56 |
| FOV [deg.] | 15.4 | R9/R10 | −0.67 |
| TL/ImgH | 5.44 | (R5 − R6)/(R5 + R6) | 0.04 |
| BL/ImgH | 3.07 | CT1/CT2 | 3.50 |
| TD/BL | 0.77 | (T12 + T23 + T45)/T34 | 0.39 |
| BL/T34 | 4.23 | T23/T45 | 0.06 |
| BL/ΣAT | 3.06 | T34/Dr1r6 | 0.67 |
| f/f3 | −0.12 | V2 | 22.5 |
| \|f1/f2\| | 0.73 | V3 | 56.0 |
| f1/f3 | −0.04 | V4 | 16.3 |
| (f1 + f2)/(f4 + f5) | −0.35 | Y3R2/Y4R1 | 1.17 |
| Dr1r6/Dr7r10 | 1.95 | Y1R1/Y5R2 | 1.66 |
| Dr2r5/Dr8r10 | 0.69 | — | — |

### 11th Embodiment

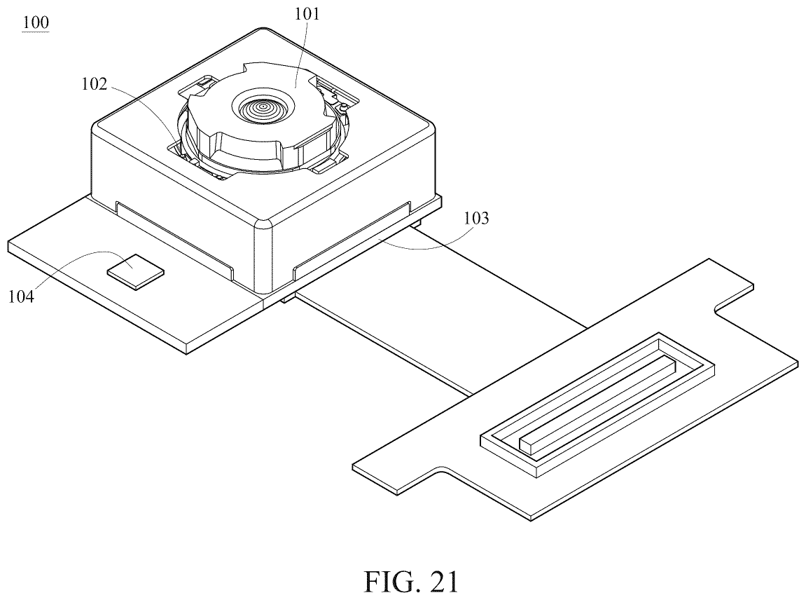

FIG. 21 is a perspective view of an image capturing unit according to the 11th embodiment of the present disclosure. In this embodiment, an image capturing unit 100 is a camera module including a lens unit 101, a driving device 102, an image sensor 103 and an image stabilizer 104. The lens unit 101 includes the imaging lens system as disclosed in the 1st embodiment, a barrel and a holder member (their reference numerals are omitted) for holding the imaging lens system. However, the lens unit 101 may alternatively be provided with the imaging lens system as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and the driving device 102 can utilize various driving configurations, such as voice coil motors (VCM), micro electro-mechanical systems (MEMS), piezoelectric systems, and shape memory alloys. The driving device 102 is favorable for obtaining a better imaging position for the lens unit 101, so that a clear image of the imaged object can be captured by the lens unit 101 with different object distances. The image sensor 103 (for example, CMOS or CCD), which can feature high photosensitivity and low noise, is disposed on the image surface of the imaging lens system to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in dynamic or low-light scenarios.

### 12th Embodiment

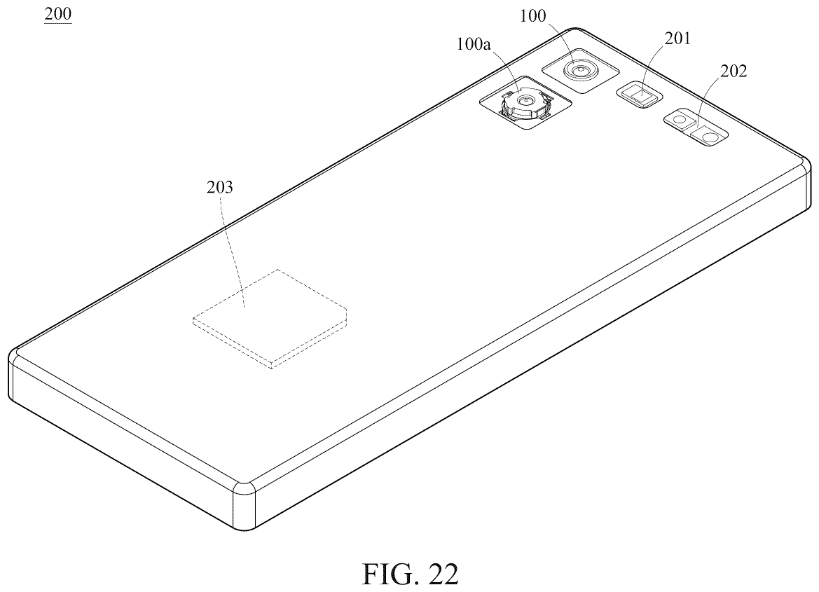

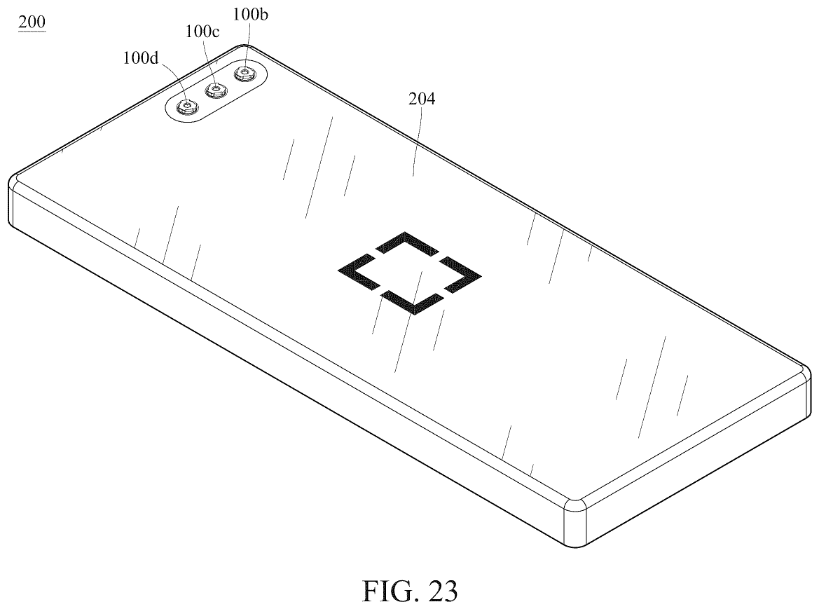

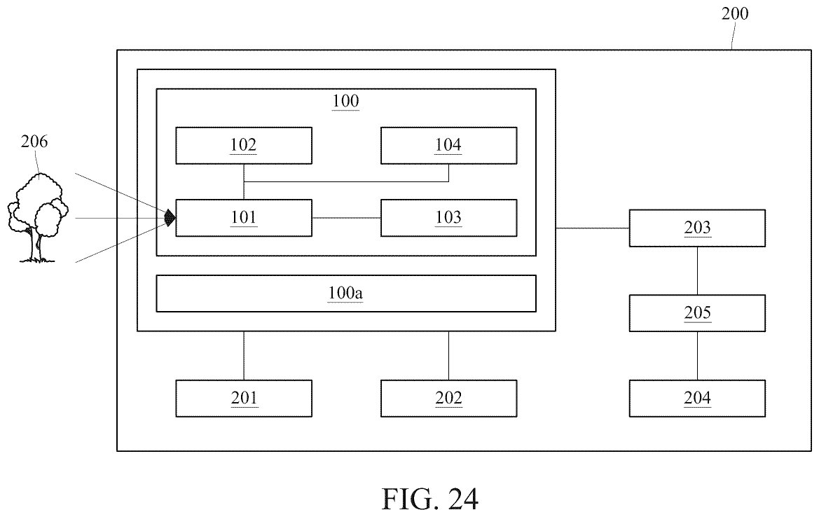

FIG. 22 is one perspective view of an electronic device according to the 12th embodiment of the present disclosure, FIG. 23 is another perspective view of the electronic device in FIG. 22, and FIG. 24 is a block diagram of the electronic device in FIG. 22.

In this embodiment, an electronic device 200 is a smartphone including the image capturing unit 100 as disclosed in the 11th embodiment, an image capturing unit 100a, an image capturing unit 100b, an image capturing unit 100c, an image capturing unit 100d, a flash module 201, a focus assist module 202, an image signal processor 203, a display module 204 and an image software processor 205. The image capturing unit 100 and the image capturing unit 100a are disposed on the same side of the electronic device 200, and each of the image capturing units 100 and 100a has a single focal point. The focus assist module 202 can be a laser rangefinder or a ToF (time of flight) module, but the present disclosure is not limited thereto. The image capturing unit 100b, image capturing unit 100c, the image capturing unit 100d and the display module 204 are disposed on the opposite side of the electronic device 200, and the display module 204 can be a user interface, allowing the image capturing units 100b, 100c and 100d to serve as front-facing cameras of the electronic device 200 for taking selfies, but the present disclosure is not limited thereto. Furthermore, each of the image capturing units 100a, 100b, 100c and 100d can include the imaging lens system of the present disclosure and can have a configuration similar to that of the image capturing unit 100. In detail, each of the image capturing units 100a, 100b, 100c and 100d can include a lens unit, a driving device, an image sensor and an image stabilizer. In addition, each lens unit of the image capturing units 100a, 100b, 100c and 100d can include the imaging lens system of the present disclosure, a barrel and a holder member for holding the imaging lens system.

The image capturing unit 100 is a telephoto image capturing unit, the image capturing unit 100a is a wide-angle image capturing unit, the image capturing unit 100b is a wide-angle image capturing unit, the image capturing unit 100c is an ultra-wide-angle image capturing unit, and the image capturing unit 100d is a ToF image capturing unit. In this embodiment, the image capturing units 100 and 100a have different fields of view, such that the electronic device 200 can have various magnification ratios so as to meet the requirement of optical zoom functionality. In addition, the image capturing unit 100d can determine depth information of the imaged object. Moreover, each of the image capturing units 100, 100a, 100b, 100c and 100d can have a light-folding configuration similar to, for example, one of the configurations as shown in FIG. 31 to FIG. 33, which can be referred to foregoing descriptions corresponding to FIG. 31 to FIG. 33. In this embodiment, the electronic device 200 includes multiple image capturing units 100, 100a, 100b, 100c and 100d, but the present disclosure is not limited to the number and arrangement of image capturing units.

When a user captures images of an object 206, the light rays converge in the image capturing unit 100 or the image capturing unit 100a to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100b, 100c or 100d to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 13th Embodiment

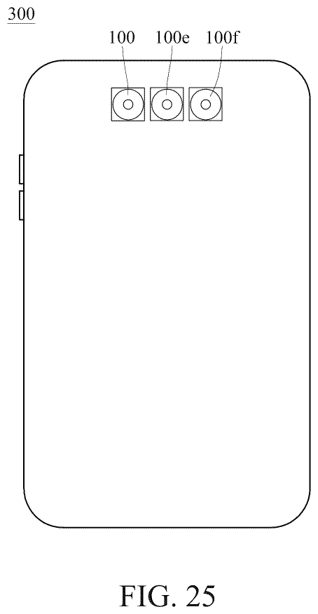

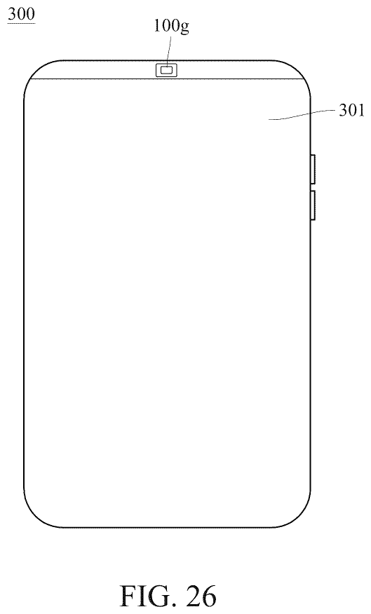

FIG. 25 is one schematic view of an electronic device according to the 13th embodiment of the present disclosure, and FIG. 26 is another schematic view of the electronic device in FIG. 25.

In this embodiment, an electronic device 300 is a smartphone including the image capturing unit 100 as disclosed in the 11th embodiment, an image capturing unit 100e, an image capturing unit 100f, an image capturing unit 100g and a display module 301. As shown in FIG. 25, the image capturing unit 100, the image capturing unit 100e and the image capturing unit 100f are disposed on the same side of the electronic device 300, and each of the image capturing units 100, 100e and 100f has a single focal point. As shown in FIG. 26, the image capturing unit 100g and the display module 301 are disposed on the opposite side of the electronic device 300, allowing the image capturing unit 100g to serve as a front-facing camera of the electronic device 300 for taking selfies, but the present disclosure is not limited thereto. Furthermore, each of the image capturing units 100e, 100f and 100g can include the imaging lens system of the present disclosure and can have a configuration similar to that of the image capturing unit 100. In detail, each of the image capturing units 100e, 100f and 100g can include a lens unit, a driving device, an image sensor and an image stabilizer. In addition, each lens unit of the image capturing units 100e, 100f and 100g can include the imaging lens system of the present disclosure, a barrel and a holder member for holding the imaging lens system.

The image capturing unit 100 is a telephoto image capturing unit, the image capturing unit 100e is a wide-angle image capturing unit, the image capturing unit 100f is an ultra-wide-angle image capturing unit, and the image capturing unit 100g is a wide-angle image capturing unit. In this embodiment, the image capturing units 100, 100e and 100f have different fields of view, such that the electronic device 300 can have various magnification ratios so as to meet the requirement of optical zoom functionality. Moreover, as shown in FIG. 26, the image capturing unit 100g can have a non-circular opening, and the barrel or lens elements in the image capturing unit 100g can have trimmed edges at their outermost positions so as to coordinate with the shape of the non-circular opening. Therefore, it is favorable for reducing the size of the image capturing unit 100g so as to increase the ratio of the area of the display module 301 relative to that of the electronic device 300, and reduce the thickness of the electronic device 300, thereby achieving compactness. In this embodiment, the electronic device 300 includes multiple image capturing units 100, 100e, 100f and 100g, but the present disclosure is not limited to the number and arrangement of image capturing units.

### 14th Embodiment

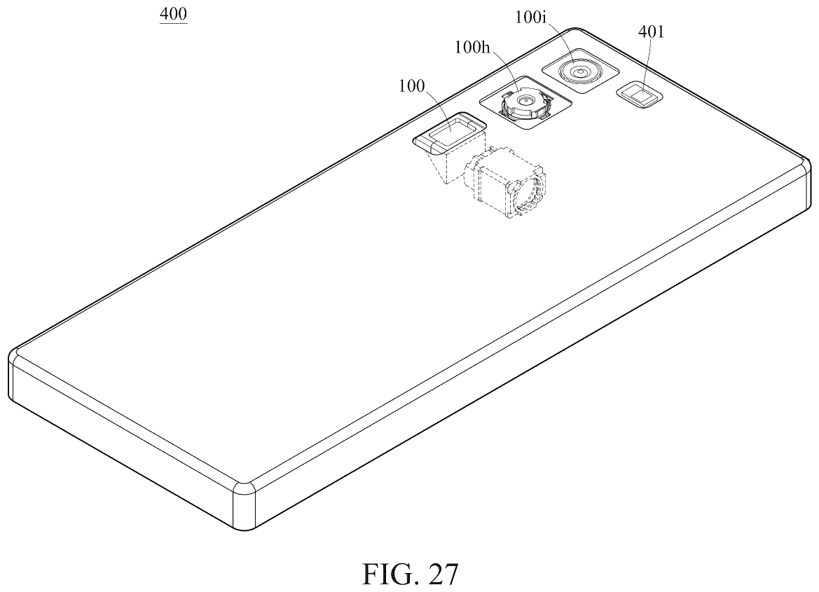

FIG. 27 is a perspective view of an electronic device according to the 14th embodiment of the present disclosure.

In this embodiment, an electronic device 400 is a smartphone including the image capturing unit 100 as disclosed in the 11th embodiment, an image capturing unit 100h, an image capturing unit 100i, a flash module 401, a focus assist module, an image signal processor, a display module, and an image software processor (not shown). The image capturing units 100, 100h and 100i are disposed on the same side of the electronic device 400, while the display module is disposed on the opposite side of the electronic device 400. Furthermore, each of the image capturing units 100h and 100i can include the imaging lens system of the present disclosure and can have a configuration similar to that of the image capturing unit 100, and the details in this regard will not be provided again.

The image capturing unit 100 is a telephoto image capturing unit with optical path folding function, the image capturing unit 100h is a wide-angle image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. In addition, the image capturing unit 100 is a telephoto image capturing unit configured with an optical path folding element (e.g., reflective element), allowing the total track length of the image capturing unit 100 to be unrestricted by the thickness of the electronic device 400. Moreover, the light-folding configuration of the image capturing unit 100 can be similar to, for example, one of the configurations as shown in FIG. 31 to FIG. 33, which can be referred to foregoing descriptions corresponding to FIG. 31 to FIG. 33, and the details in this regard will not be provided again. Moreover, each of the image capturing units 100h and 100i can have a light-folding configuration similar to, for example, one of the configurations as shown in FIG. 31 to FIG. 33, which can be referred to foregoing descriptions corresponding to FIG. 31 to FIG. 33. In this embodiment, the electronic device 400 includes multiple image capturing units 100, 100h and 100i, but the present disclosure is not limited to the number and arrangement of image capturing units. When a user captures images of an object, the light rays converge in the image capturing unit 100, 100h or 100i to generate images, and the flash module 401 is activated for light supplement. Further, the subsequent processes are performed in a manner similar to the abovementioned embodiments, and the details in this regard will not be provided again.

### 15th Embodiment

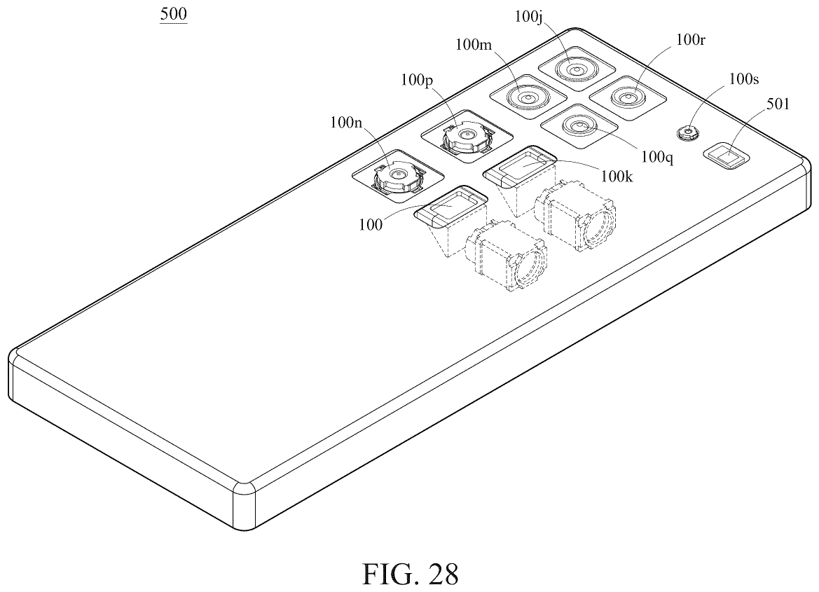

FIG. 28 is a perspective view of an electronic device according to the 15th embodiment of the present disclosure.

In this embodiment, an electronic device 500 is a smartphone including the image capturing unit 100 as disclosed in the 11th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module, and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the imaging lens system of the present disclosure and can have a configuration similar to that of the image capturing unit 100, and the details in this regard will not be provided again.

The image capturing unit 100 is a telephoto image capturing unit with optical path folding function, the image capturing unit 100k is a telephoto image capturing unit with optical path folding function, the image capturing unit 100j is an ultra-wide-angle image capturing unit, the image capturing unit 100m is an ultra-wide-angle image capturing unit, the image capturing unit 100n is a wide-angle image capturing unit, the image capturing unit 100p is a wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. In addition, each of the image capturing unit 100 and the image capturing unit 100k is a telephoto image capturing unit configured with an optical path folding element (e.g., reflective element), allowing the total track lengths of the image capturing unit 100 and the image capturing unit 100k to be unrestricted by the thickness of the electronic device 500. Moreover, the image capturing unit 100s can determine depth information of the imaged object. Moreover, the light-folding configuration of the image capturing units 100 and 100k can be similar to, for example, one of the configurations as shown in FIG. 31 to FIG. 33, which can be referred to foregoing descriptions corresponding to FIG. 31 to FIG. 33, and the details in this regard will not be provided again. Moreover, each of the image capturing units 100j, 100m, 100n, 100p, 100q, 100r and 100s can have a light-folding configuration similar to, for example, one of the configurations as shown in FIG. 31 to FIG. 33, which can be referred to foregoing descriptions corresponding to FIG. 31 to FIG. 33. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

The smartphones in the embodiments are only exemplary for showing the image capturing unit of the present disclosure installed in an electronic device, and the present disclosure is not limited thereto. The image capturing unit can be optionally applied to optical systems with a movable focus. Furthermore, the imaging lens system of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, vehicles, unmanned aerial vehicles, wearable devices, portable video recorders, and other electronic imaging devices.

The foregoing description, for the purpose of explanation, has been described with reference to specific embodiments. It is to be noted that TABLES 1A-10C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens system comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the first lens element has positive refractive power, the second lens element has negative refractive power, and the image-side surface of the second lens element is concave in a paraxial region thereof; and
wherein an axial distance between the object-side surface of the first lens element and the image-side surface of the third lens element is Dr1r6, an axial distance between the object-side surface of the fourth lens element and the image-side surface of the fifth lens element is Dr7r10, an axial distance between the object-side surface of the first lens element and the image-side surface of the fifth lens element is TD, an axial distance between the image-side surface of the fifth lens element and an image surface is BL, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, an Abbe number of the fourth lens element is V4, a curvature radius of the image-side surface of the second lens element is R4, a curvature radius of the image-side surface of the fifth lens element is R10, and the following conditions are satisfied:
$$1.6 < Dr 1 r 6 / Dr 7 r 10 < 5. ;$$
$$0.5 < TD / BL < 1.5 ;$$
$$0. < ( T 12 + T 23 + T 45 ) / T 34 < 0 \text{.50} ;$$
$$0. < T 23 / T 45 < 0 \text{.50} ;$$
$$5. < V 4 < 35. ; and$$
$$0. < \vert R 4 / R 10 \vert < 1. .$$

2. The imaging lens system of claim 1, wherein the object-side surface of the first lens element is convex in a paraxial region thereof, the object-side surface of the second lens element is convex in a paraxial region thereof, the object-side surface of the third lens element is convex in a paraxial region thereof, and the image-side surface of the third lens element is concave in a paraxial region thereof; and
wherein a focal length of the imaging lens system is f, a focal length of the third lens element is f3, and the following condition is satisfied:
$$- 0.25 < f / f 3 < 5.00 .$$

3. The imaging lens system of claim 1, wherein at least one lens element of the imaging lens system has at least one inflection point; and
wherein the axial distance between the image-side surface of the fifth lens element and the image surface is BL, a maximum image height of the imaging lens system is ImgH, an axial distance between the object-side surface of the first lens element and the image surface is TL, and the following conditions are satisfied:
$$2.2 < BL / ImgH < 3.5 ; and$$
$$4. < TL / ImgH < 7. .$$

4. The imaging lens system of claim 1, wherein a focal length of the first lens element is f1, a focal length of the second lens element is f2, and the following condition is satisfied:
$$0.5 < \vert f 1 / f 2 \vert < 1.5 .$$

5. The imaging lens system of claim 1, wherein a focal length of the first lens element is f1, a focal length of the third lens element is f3, and the following condition is satisfied:
$$0.4 < f 1 / f 3 < 1.5 .$$

6. The imaging lens system of claim 1, wherein a focal length of the first lens element is f1, a focal length of the second lens element is f2, a focal length of the fourth lens element is f4, a focal length of the fifth lens element is f5, and the following condition is satisfied:
$$- 0.60 < ( f 1 + f 2 ) / ( f 4 + f 5 ) < 5.00 .$$

7. The imaging lens system of claim 1, wherein a curvature radius of the image-side surface of the third lens element is R6, a curvature radius of the object-side surface of the fourth lens element is R7, a curvature radius of the object-side surface of the fifth lens element is R9, the curvature radius of the image-side surface of the fifth lens element is R10, and the following conditions are satisfied:
$$- 1.8 < R 9 / R 10 < 1. ; and$$
$$- 1. < R 6 / R 7 < 1.1 .$$

8. The imaging lens system of claim 1, wherein the imaging lens system further comprises at least one reflective element.

9. The imaging lens system of claim 1, wherein an axial distance between the image-side surface of the first lens element and the object-side surface of the third lens element is Dr2r5, an axial distance between the image-side surface of the fourth lens element and the image-side surface of the fifth lens element is Dr8r10, and the following condition is satisfied:
$$0. < Dr 2 r 5 / Dr 8 r 10 < 1.7 .$$

10. The imaging lens system of claim 1, wherein an Abbe number of the second lens element is V2, an Abbe number of the third lens element is V3, and the following conditions are satisfied:
$$5. < V 2 < 35. ; and$$
$$45. < V 3 < 70.0 .$$

11. The imaging lens system of claim 1, wherein a maximum effective radius of the image-side surface of the third lens element is Y3R2, a maximum effective radius of the object-side surface of the fourth lens element is Y4R1, and the following condition is satisfied:
$$1. 20 < Y 3 R 2 / Y 4 R 1 < 1.9 .$$

12. The imaging lens system of claim 1, wherein the axial distance between the object-side surface of the first lens element and the image-side surface of the third lens element is Dr1r6, the axial distance between the object-side surface of the fourth lens element and the image-side surface of the fifth lens element is Dr7r10, the axial distance between the object-side surface of the first lens element and the image-side surface of the fifth lens element is TD, the axial distance between the image-side surface of the fifth lens element and the image surface is BL, the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, and the following conditions are satisfied:
$$1.7 < Dr 1 r 6 / Dr 7 r 10 < 4. ;$$
$$0.6 < TD / BL < 1.2 ;$$
$$0. < T 23 / T 45 < 0.4 ; and$$
$$0.05 < ( T 12 + T 23 + T 45 ) / T 34 < 0.45 .$$

13. An image capturing unit comprising:
the imaging lens system of claim 1; and
an image sensor disposed on the image surface of the imaging lens system.

14. An electronic device comprising:
the image capturing unit of claim 13.

15. An imaging lens system comprising five lens elements, the five lens elements being, in order from an object side to an image side along an optical path, a first lens element, a second lens element, a third lens element, a fourth lens element and a fifth lens element, and each of the five lens elements having an object-side surface facing toward the object side and an image-side surface facing toward the image side;
wherein the first lens element has positive refractive power, the second lens element has negative refractive power, the object-side surface of the second lens element is convex in a paraxial region thereof, and the object-side surface of the fifth lens element is concave in a paraxial region thereof; and
wherein an axial distance between the object-side surface of the first lens element and the image-side surface of the third lens element is Dr1r6, an axial distance between the object-side surface of the fourth lens element and the image-side surface of the fifth lens element is Dr7r10, an axial distance between the object-side surface of the first lens element and the image-side surface of the fifth lens element is TD, an axial distance between the image-side surface of the fifth lens element and an image surface is BL, an axial distance between the first lens element and the second lens element is T12, an axial distance between the second lens element and the third lens element is T23, an axial distance between the third lens element and the fourth lens element is T34, an axial distance between the fourth lens element and the fifth lens element is T45, and the following conditions are satisfied:
$$1.6 < Dr 1 r 6 / Dr 7 r 10 < 5. ;$$
$$0.5 < TD / BL < 1.5 ;$$
$$0. < ( T 12 + T 23 + T 45 ) / T 34 < 0.5 ; and$$
$$0. < T 23 / T 45 < 0.50 .$$

16. The imaging lens system of claim 15, wherein the object-side surface of the first lens element is convex in a paraxial region thereof, the image-side surface of the second lens element is concave in a paraxial region thereof, the object-side surface of the third lens element is convex in a paraxial region thereof, and the fourth lens element has positive refractive power; and
wherein a focal length of the imaging lens system is f, a focal length of the third lens element is f3, and the following condition is satisfied:
$$- 0.20 < f / f 3 < 2.00 .$$

17. The imaging lens system of claim 15, wherein at least one lens element of the imaging lens system has at least one inflection point; and
wherein a maximum field of view of the imaging lens system is FOV, and the following condition is satisfied:
$$10. degrees < FOV < 25. degrees .$$

18. The imaging lens system of claim 15, wherein the axial distance between the image-side surface of the fifth lens element and the image surface is BL, the axial distance between the third lens element and the fourth lens element is T34, and the following condition is satisfied:
$$1. 00 < BL / T 34 < 4.50 .$$

19. The imaging lens system of claim 15, wherein a curvature radius of the image-side surface of the first lens element is R2, a curvature radius of the object-side surface of the second lens element is R3, and the following condition is satisfied:
$$0. < \vert R 3 / R 2 \vert < 1.1 .$$

20. The imaging lens system of claim 15, wherein a curvature radius of the object-side surface of the third lens element is R5, a curvature radius of the image-side surface of the third lens element is R6, and the following condition is satisfied:
$$- 0.50 < ( R 5 - R 6 ) / ( R 5 + R 6 ) < 1. .$$

21. The imaging lens system of claim 15, wherein a central thickness of the first lens element is CT1, a central thickness of the second lens element is CT2, and the following condition is satisfied:
$$2. < CT 1 / CT 2 < 5.50 .$$

22. The imaging lens system of claim 15, wherein the axial distance between the image-side surface of the fifth lens element and the image surface is BL, a sum of axial distances between each of all adjacent lens elements of the imaging lens system is ΣAT, and the following condition is satisfied:
$$1. 70 < BL / \sum AT < 3.80 .$$

23. The imaging lens system of claim 15, wherein the axial distance between the third lens element and the fourth lens element is T34, the axial distance between the object-side surface of the first lens element and the image-side surface of the third lens element is Dr1r6, and the following condition is satisfied:
$$0.5 < T 34 / D r 1 r 6 < 1.6 .$$

24. The imaging lens system of claim 15, wherein a maximum effective radius of the object-side surface of the first lens element is Y1R1, a maximum effective radius of the image-side surface of the fifth lens element is Y5R2, and the following condition is satisfied:
$$1. 60 < Y 1 R 1 / Y 5 R 2 < 3.50 .$$

25. The imaging lens system of claim 15, wherein the axial distance between the object-side surface of the first lens element and the image-side surface of the third lens element is Dr1r6, the axial distance between the object-side surface of the fourth lens element and the image-side surface of the fifth lens element is Dr7r10, the axial distance between the object-side surface of the first lens element and the image-side surface of the fifth lens element is TD, the axial distance between the image-side surface of the fifth lens element and the image surface is BL, the axial distance between the first lens element and the second lens element is T12, the axial distance between the second lens element and the third lens element is T23, the axial distance between the third lens element and the fourth lens element is T34, the axial distance between the fourth lens element and the fifth lens element is T45, an Abbe number of the fourth lens element is V4, a curvature radius of the image-side surface of the second lens element is R4, a curvature radius of the image-side surface of the fifth lens element is R10, and the following conditions are satisfied:
$$1.81 \leq Dr 1 r 6 / Dr 7 r 10 \leq 3.58 ;$$
$$0.77 \leq TD / BL \leq 1.02 ;$$
$$0.1 \leq ( T 12 + T 23 + T 45 ) / T 34 \leq 0 \text{.42} ;$$
$$0.05 \leq T 23 / T 45 \leq 0 \text{.35} ;$$
$$16.3 \leq V 4 \leq 25.3 ; and$$
$$0.06 \leq \vert R 4 / R 10 \vert \leq 0.7 2 .$$
